(19) United States
(12) Patent Application Publication
(10) Pub. No.: US 2025/0328976 A1
(43) Pub. Date: Oct. 23, 2025

(54) TICKET CHECKING SYSTEM, INFORMATION PROCESSING METHOD, AND NON-TRANSITORY COMPUTER-READABLE MEDIUM

(71) Applicant: NEC Corporation, Minato-ku, Tokyo (JP)

(72) Inventor: Kazuki AIBA, Tokyo (JP)

(73) Assignee: NEC Corporation, Minato-ku, Tokyo (JP)

(21) Appl. No.: 18/873,369

(22) PCT Filed: Jul. 1, 2022
(86) PCT No.: PCT/JP2022/026464

§ 371 Date: Dec. 10, 2024

(51) Int. Cl. G06Q 50/40; G06F 21/32

(52) U.S. Cl. CPC G06Q 50/40; G06F 21/32

(57) ABSTRACT

An information processing apparatus includes a determination unit that determines, by face authentication, a person who has passed through a gate of a ticket barrier of transportation, a settlement processing unit that performs settlement processing of a fare for the determined person, a transmission unit that transmits, to a terminal of the determined person, information indicating that the transportation has been utilized, and a refund processing unit that executes refund processing for the settled fare in a case where predetermined information is acquired from the terminal.

### TECHNICAL FIELD

The present invention relates to a ticket checking system, an information processing method, and a medium.

### BACKGROUND ART

One example of an automatic ticket checking apparatus with a face collation function is described in Patent Document 1. A system in Patent Document 1 includes a storage apparatus that previously stores authentication information of a plurality of users and passage permission information of the users in association with each other, an automatic ticket checking apparatus that restricts acceptability of passage of a user, a biological information acquisition apparatus that acquires biological information of a user passing through the automatic ticket checking apparatus, and a control apparatus that collates determination information of the biological information acquired by the biological information acquisition apparatus with authentication information stored in the storage apparatus, decides whether the user is able to pass, based on the passage permission information stored in association with the authentication information derived based on a collation result, and outputs a passage permission signal to the automatic ticket checking apparatus in a case where the user is able to pass.

### RELATED DOCUMENT

### Patent Document

Patent Document 1: Japanese Patent Application Publication No. 2021-47672

### SUMMARY OF INVENTION

### Technical Problem

A technique described in Patent Document 1 relates to a system that manages passage permission and passage non-permission through an automatic ticket checking apparatus by face authentication or QR code authentication. Thus, the technique described in Patent Document 1 cannot solve such a problem that, in a case where a criterion of face authentication is tightened in a ticket barrier utilizing a face authentication gate, a rate of erroneous authentication is reduced, and an incidence of erroneous charging of a fare is reduced, but a passage ratio of a gate deteriorates and convenience is impaired, whereas, in a case where a criterion of face authentication is loosened, a passage ratio of a gate improves, but a rate of erroneous authentication increases and an incidence of erroneous charging of a fare rises.

Accordingly, the present inventor considered appropriately controlling an incidence of erroneous charging of a fare and a passage ratio of a gate in a ticket barrier that utilizes a face authentication gate. Then, the present inventor considered providing further convenience to a user in the ticket checking system.

In view of the problem described above, one example of an object of the present invention is to provide a ticket checking system, an information processing method, and a medium that solve a problem of an increase in an incidence of erroneous charging of a fare and a reduction in a passage ratio of a gate in a ticket barrier utilizing a face authentication gate.

### Solution to Problem

According to one aspect of the present invention, there is provided a ticket checking system including:
a determination unit that determines, by face authentication, a person who has passed through a gate of a ticket barrier of transportation;
a settlement processing unit that performs settlement processing of a fare for the determined person;
a transmission unit that transmits, to a terminal of the determined person, information indicating that the transportation has been utilized; and
a refund processing unit that executes refund processing for the settled fare in a case where predetermined information is acquired from the terminal.

According to one aspect of the present invention, there is provided a ticket checking system including:
a gate control unit that permits, in a case where a payment method of a fare of transportation is a commuter pass, passage of a person for whom a face authentication result satisfies a first criterion through a gate of the ticket barrier of the transportation; and
a settlement processing unit that performs, in a case where the payment method is deposit balance payment, settlement processing of the fare for a person for whom the face authentication result satisfies a second criterion being tighter than the first criterion.

According to one aspect of the present invention, there is provided a ticket checking system including:
a decision unit that decides whether a payment method of a fare by a user of transportation is a commuter pass or deposit balance payment;
an authentication unit that sets a threshold value for face authentication according to the decided payment method, and performs the face authentication of the user by use of the threshold value;
a gate control unit that permits, in a case where the payment method is the commuter pass, passage of the user through a gate of a ticket barrier of the transportation in a case where the face authentication is successful; and
a settlement processing unit that performs, in a case where the payment method is the deposit balance payment, settlement processing of the fare for the user who is successful in the face authentication.

According to one aspect of the present invention, there is provided an information processing method including, by one or more computers:
determining, by face authentication, a person who has passed through a gate of a ticket barrier of transportation;
performing settlement processing of a fare for the determined person;
transmitting, to a terminal of the determined person, information indicating that the transportation has been utilized; and
executing refund processing for the settled fare in a case where predetermined information is acquired from the terminal.

According to one aspect of the present invention, there is provided an information processing method including,
by one or more computers:
permitting, in a case where a payment method of a fare of transportation is a commuter pass, passage of a person for whom a face authentication result satisfies a first criterion through a gate of the ticket barrier of the transportation; and
performing, in a case where the payment method is deposit balance payment, settlement processing of the fare for a person for whom the face authentication result satisfies a second criterion being tighter than the first criterion.

According to one aspect of the present invention, there is provided an information processing method including,
by one or more computers:
deciding whether a payment method of a fare by a user of transportation is a commuter pass or deposit balance payment;
setting a threshold value for face authentication according to the decided payment method, and performing the face authentication of the user by use of the threshold value;
permitting, in a case where the payment method is the commuter pass, passage of the user through a gate of a ticket barrier of the transportation in a case where the face authentication is successful; and
performing, in a case where the payment method is the deposit balance payment, settlement processing of the fare for the user who is successful in the face authentication.

According to one aspect of the present invention, there is provided a computer-readable medium storing a program for causing a computer to execute:
a procedure of determining, by face authentication, a person who has passed through a gate of a ticket barrier of transportation;
a procedure of performing settlement processing of a fare for the determined person;
a procedure of transmitting, to a terminal of the determined person, information indicating that the transportation has been utilized; and
a procedure of executing refund processing for the settled fare in a case where predetermined information is acquired from the terminal.

According to one aspect of the present invention, there is provided a computer-readable medium storing a program for causing a computer to execute:
a procedure of permitting, in a case where a payment method of a fare of transportation is a commuter pass, passage of a person for whom a face authentication result satisfies a first criterion through a gate of the ticket barrier of the transportation; and
a procedure of performing, in a case where the payment method is deposit balance payment, settlement processing of the fare for a person for whom the face authentication result satisfies a second criterion being tighter than the first criterion.

According to one aspect of the present invention, there is provided a computer-readable medium storing a program for causing a computer to execute:
a procedure of deciding whether a payment method of a fare by a user of transportation is a commuter pass or deposit balance payment;
a procedure of setting a threshold value for face authentication according to the decided payment method, and performing the face authentication of the user by use of the threshold value;
a procedure of permitting, in a case where the payment method is the commuter pass, passage of the user through a gate of a ticket barrier of the transportation in a case where the face authentication is successful; and
a procedure of performing, in a case where the payment method is the deposit balance payment, settlement processing of the fare for the user who is successful in the face authentication.

Note that, another aspect of the present invention may be a program that causes at least one or more computers to execute the method according to the one aspect described above, or may be a computer-readable medium recording such a program. The medium includes a non-transitory tangible medium.

The computer program includes a computer program code that causes, in a case of being executed by a computer, the computer to implement the information processing method on an information processing apparatus.

Note that, any combination of the components described above, and conversion of an expression according to the present invention between a method, an apparatus, a system, a medium, a computer programs, and the like are also effective as an aspect according to the present invention.

Moreover, various components according to the present invention do not necessarily need to be individually independent existences, and it may be such that a plurality of components are formed as a single member, one component is formed of a plurality of members, a certain component is a part of another component, or a part of a certain component overlaps with a part of another component.

Moreover, although a method and a computer program according to the present invention describe a plurality of procedures in order, the described order does not limit order of executing a plurality of procedures. Thus, in a case where the method and the computer program according to the present invention are implemented, the order of the plurality of procedures can be changed to an extent that causes no problem in terms of content.

Further, a plurality of procedures of the method and the computer program according to the present invention are not limited to being executed at individually different timing. Thus, it may be such that another procedure occurs while a certain procedure is executed, or execution timing of a certain procedure and execution timing of another procedure partially or entirely overlap with each other.

### Advantageous Effects of Invention

According to one aspect of the present invention, a ticket checking system, an information processing apparatus, an information processing method, and program that solve a problem of an increase in an incidence of erroneous charging of a fare and a reduction in a passage ratio of a gate in a ticket barrier utilizing a face authentication gate can be acquired.

### BRIEF DESCRIPTION OF THE DRAWINGS

FIG. 1 It is a diagram illustrating an outline of an information processing apparatus according to an example embodiment.

FIG. 2 It is a flowchart illustrating an operation example of the information processing apparatus according to the example embodiment.

FIG. 3 It is a diagram illustrating an outline of an information processing apparatus according to another example embodiment.

FIG. 4 It is a flowchart illustrating an operation example of the information processing apparatus according to the example embodiment.

FIG. 5 It is a diagram illustrating an outline of an information processing apparatus according to yet another example embodiment.

FIG. 6 It is a flowchart illustrating an operation example of the information processing apparatus according to the example embodiment.

FIG. 7 It is a diagram for describing a ticket gate machine of transportation.

FIG. 8 It is a diagram conceptually illustrating a system configuration of a ticket checking system 1 according to the example embodiment.

FIG. 9 It is a block diagram illustrating a hardware configuration of a computer that implements the information processing apparatus.

FIG. 10 It is a diagram illustrating a data structure example of master authentication information.

FIG. 11 It is a diagram illustrating one example of transportation utilization information.

FIG. 12 It is a diagram illustrating a data structure example of user information.

FIG. 13 It is a diagram illustrating one example of a notification screen.

FIG. 14 It is a flowchart illustrating a detailed example of an operation of the information processing apparatus and a user terminal in step S105 of FIG. 2 in the ticket checking system according to the example embodiment.

FIG. 15 It is a functional block diagram illustrating a functional configuration example of the information processing apparatus according to an example embodiment.

FIG. 16 It is a flowchart illustrating an operation example of the information processing apparatus according to the example embodiment.

FIG. 17 It is a diagram illustrating a data structure example of master authentication information and user information.

FIG. 18 It is a flowchart illustrating an operation example of the information processing apparatus according to the example embodiment.

FIG. 19 It is a functional block diagram illustrating a functional configuration example of the information processing apparatus according to an example embodiment.

FIG. 20 It is a flowchart illustrating an operation example of the information processing apparatus according to the example embodiment.

FIG. 21 It is a flowchart illustrating an operation example of the information processing apparatus according to an example embodiment.

FIG. 22 It is a functional block diagram illustrating a functional configuration example of an information processing apparatus according to an example embodiment.

FIG. 23 It is a flowchart illustrating an operation example of the information processing apparatus according to the example embodiment.

FIG. 24 It is a functional block diagram illustrating a functional configuration example of the information processing apparatus according to an example embodiment.

FIG. 25 It is a diagram illustrating one example of a notification screen.

FIG. 26 It is a flowchart illustrating an operation example of the information processing apparatus according to the example embodiment.

FIG. 27 It is a functional block diagram illustrating a functional configuration example of an information processing apparatus according to an example embodiment.

FIG. 28 It is a flowchart illustrating an operation example of the information processing apparatus according to the example embodiment.

### EXAMPLE EMBODIMENT

Hereinafter, example embodiments according to the present invention are described by use of the drawings. Note that, in all the drawings, a similar component is assigned with a similar reference sign, and description thereof is not included as appropriate. Moreover, in each of the following figures, a configuration of a part that is not related to an essence of the present invention is not included and not illustrated.

In the example embodiment, “acquisition” includes at least one of fetching, by a local apparatus, data or information stored in another apparatus or a storage medium (active acquisition), and inputting, into a local apparatus, data or information output from another apparatus (passive acquisition). Examples of active acquisition include requesting or inquiring of the another apparatus and receiving a reply thereof, accessing the another apparatus or the storage medium and reading, and the like. Moreover, an example of passive acquisition includes receiving information given by distribution (or transmission, push notification, or the like), and the like. Further, “acquisition” may include selecting and acquiring from received data or information, or selecting and receiving distributed data or information.

### Minimum Configuration Example 1

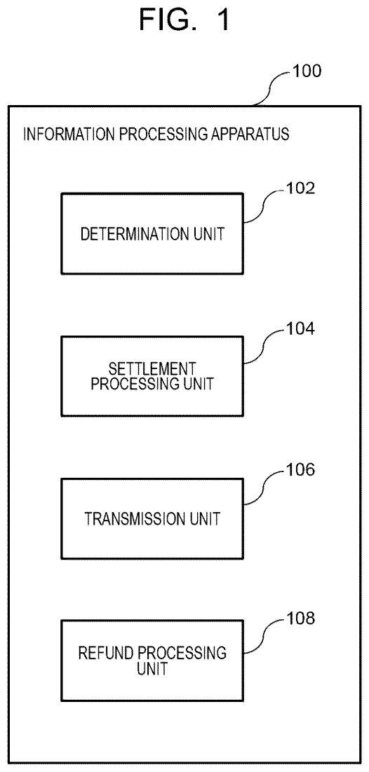

FIG. 1 is a diagram illustrating an outline of an information processing apparatus 100 according to the example embodiment. The information processing apparatus 100 includes a determination unit 102, a settlement processing unit 104, a transmission unit 106, and a refund processing unit 108.

The determination unit 102 determines, by face authentication, a person who has passed through a gate of a ticket barrier of transportation.

The settlement processing unit 104 performs settlement processing of a fare for the determined person.

The transmission unit 106 transmits, to a terminal of the determined person, information indicating that the transportation has been utilized.

The refund processing unit 108 executes refund processing for the settled fare in a case where predetermined information is acquired from the terminal.

Herein, the predetermined information is information indicating that the transportation has not been utilized.

### Operation Example

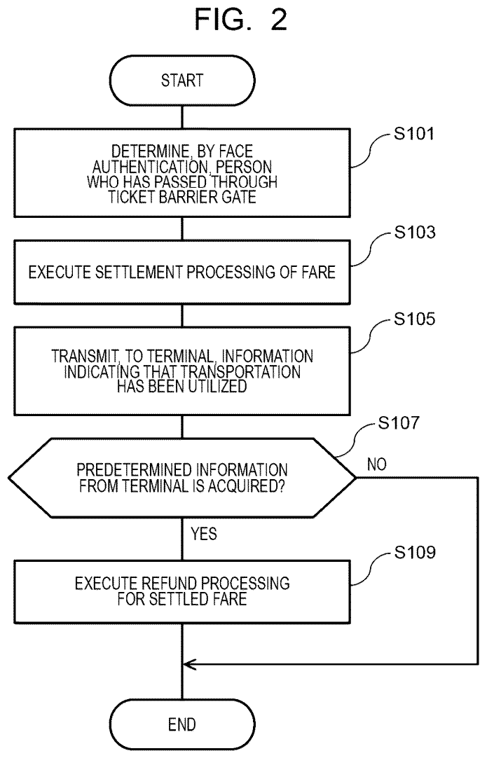

FIG. 2 is a flowchart illustrating an operation example of the information processing apparatus 100 according to the present example embodiment.

First, the determination unit 102 determines, by face authentication, a person who has passed through a gate of a ticket barrier of transportation (step S101). The settlement processing unit 104 performs settlement processing of a fare for the determined person (step S103). The transmission unit 106 transmits, to a terminal of the determined person, information indicating that the transportation has been utilized (step S105). In a case where the refund processing unit 108 acquires predetermined information from the terminal (YES in step S107), that is to say, a person being an owner of the terminal that has received the information indicating that the transportation has been utilized returns information indicating that the transportation has not been utilized, the refund processing unit 108 executes refund processing for the settled fare for the person (step S109), and ends the present processing.

In a case where the predetermined information is not acquired from the terminal (NO in step S107), the refund processing is not necessary since the person utilizes the transportation, therefore, step S109 is bypassed, and the present processing is ended. Step S107 may wait for acquisition of information from the terminal for a previously determined period. Moreover, in a case where the previously determined period has expired, but predetermined information is acquired, step S109 may be executed.

The information processing apparatus 100 can solve a problem of an increase in an incidence of erroneous charging of a fare and a reduction in a passage ratio of a gate in a ticket barrier utilizing a face authentication gate.

### Minimum Configuration Example 2

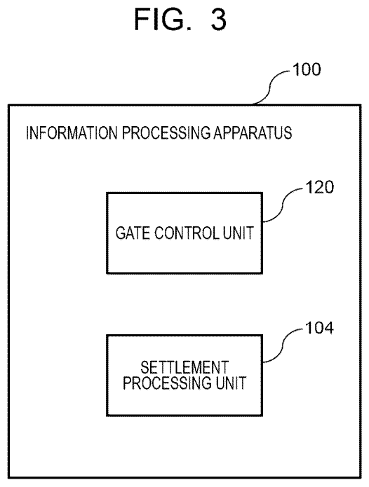

FIG. 3 is a diagram illustrating an outline of an information processing apparatus 100 according to another example embodiment. The information processing apparatus 100 includes a gate control unit 120 and a settlement processing unit 104.

The gate control unit 120 permits, in a case where a payment method of a fare of transportation is a commuter pass, passage of a person for whom a face authentication result satisfies a first criterion through a gate of the ticket barrier of the transportation.

The settlement processing unit 104 performs, in a case where the payment method is deposit balance payment, settlement processing of the fare for a person for whom the face authentication result satisfies a second criterion being tighter than the first criterion.

### Operation Example

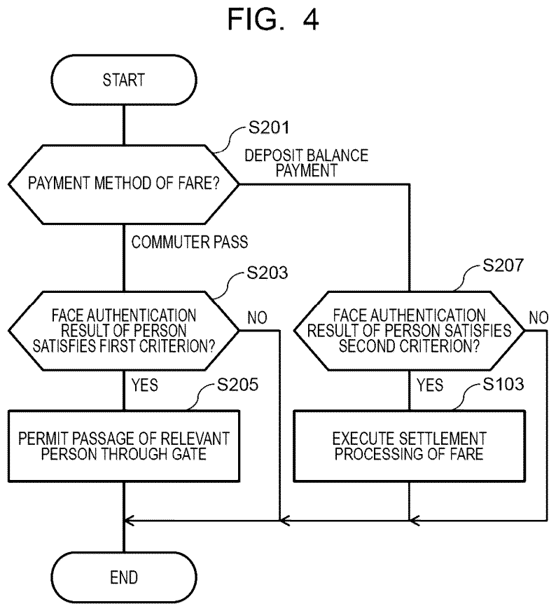

FIG. 4 is a flowchart illustrating an operation example of the information processing apparatus 100 according to the present example embodiment.

The gate control unit 120 permits, in a case where a payment method of a fare of transportation is a commuter pass (a commuter pass in step S201), passage through a gate of the ticket barrier of the transportation, regarding a person for whom a face authentication result satisfies a first criterion (YES in step S203) (step S205).

The settlement processing unit 104 performs, in a case where the payment method is deposit balance payment (deposit balance payment in step S201), settlement processing of the fare for a person for whom the face authentication result satisfies a second criterion being tighter than the first criterion (YES in step S207) (step S103).

The information processing apparatus 100 can solve a problem of an increase in an incidence of erroneous charging of a fare and a reduction in a passage ratio of a gate in a ticket barrier utilizing a face authentication gate.

### Minimum Configuration Example 3

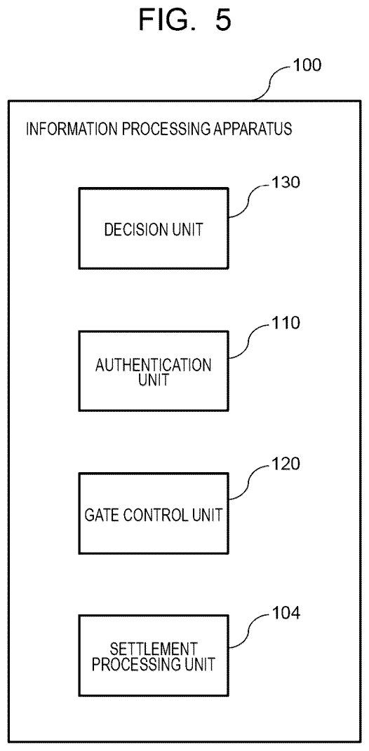

FIG. 5 is a diagram illustrating an outline of an information processing apparatus 100 according to yet another example embodiment. The information processing apparatus 100 includes a decision unit 130, an authentication unit 110, a gate control unit 120, and a settlement processing unit 104.

The gate control unit 120 decides whether a payment method of a fare by a user of transportation is a commuter pass or deposit balance payment.

The authentication unit 110 sets a threshold value for face authentication according to the decided payment method, and performs the face authentication of the user by use of the threshold value.

The gate control unit 120 permits, in a case where the payment method is the commuter pass, passage of the user through a gate of a ticket barrier of the transportation when the face authentication is successful.

The settlement processing unit 104 performs, in a case where the payment method is the deposit balance payment, settlement processing for the user who is successful in the face authentication.

### Operation Example

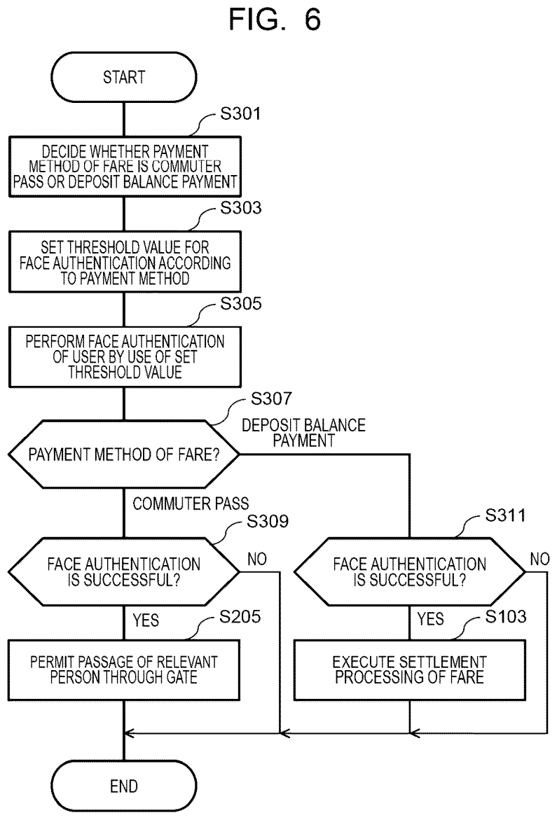

FIG. 6 is a flowchart illustrating an operation example of the information processing apparatus 100 according to the present example embodiment.

The decision unit 130 decides whether a payment method of a fare by a user of transportation is a commuter pass or deposit balance payment (step S301).

The authentication unit 110 sets a threshold value for face authentication according to the decided payment method (step S303), and performs the face authentication of the user by use of the threshold value (step S305).

The gate control unit 120 permits, in a case where the payment method is the commuter pass (a commuter ticket in step S307), passage of the user through a gate of a ticket barrier of the transportation when the face authentication is successful (YES in step S309) (step S205).

The settlement processing unit 104 performs, in a case where the payment method is the deposit balance payment (step S307, deposit balance payment), settlement processing of the fare for the user who is successful in the face authentication (YES in step S311) (step S103).

The information processing apparatus 100 can solve a problem of an increase in an incidence of erroneous charging of a fare and a reduction in a passage ratio of a gate in a ticket barrier utilizing a face authentication gate.

A detailed example of the information processing apparatus 100 is described below.

### First Example Embodiment

### <System Outline>

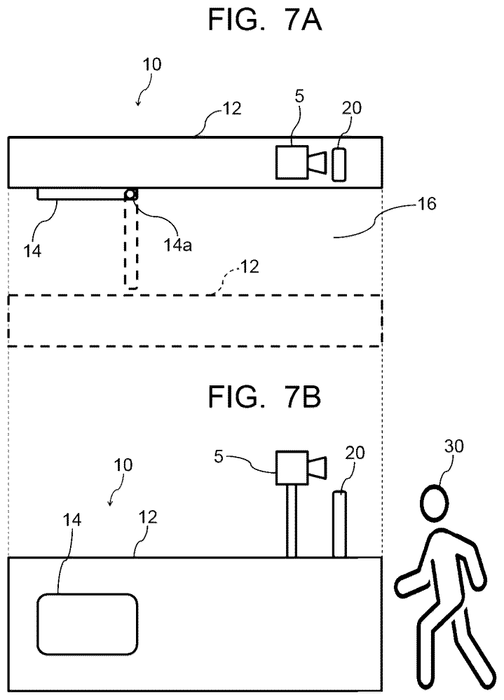

FIG. 7 is a diagram for describing a ticket gate machine 10 of transportation. FIG. 7(a) is a top view of the ticket gate machine 10. FIG. 7(b) is an elevational view of the ticket gate machine 10. The ticket gate machine 10 includes a housing 12 and a gate 14. The housing 12 has a predetermined height, and extends for a predetermined distance along the passage 16 through which a user 30 passes. The two housings 12 are installed side by side along the passage 16 on both sides of the passage 16 with an interval of a predetermined distance. Preferably, the two housings 12 are installed in parallel. In other words, the passage 16 is formed by the housing 12. However, the adjacent housings 12 may be partition walls with a predetermined height.

An entrance side of the passage 16 is open. The gate 14 is openably and closably provided on an exit side of the passage 16. Opening and closing control of the gate 14 is performed by a ticket barrier control apparatus 50 described later. The ticket barrier control apparatus 50 performs opening control of the gate 14 in such a way that a person whose passage is permitted can pass through the passage 16, and performs closing control of the gate 14 in such a way that a person whose passage is not permitted cannot pass through the passage 16. In the example of this figure, the gate 14 rotates around one end 14a of a door, and can thereby block the passage 16 according to a rest position of the gate 14 (a position indicated by a broken line in the figure), or open the passage 16 (a position indicated by a solid line in the figure).

The gate 14 may be in an open position during a normal time, and in a closed position in a case of prohibiting passage, or may be in a closed position during a normal time, and in an open position in a case of permitting passage.

In the example of this figure, a camera 5 and a display apparatus 20 are installed at an upper part of the housing 12 on an entrance side.

The camera 5 includes a lens and an image capturing element such as a charge coupled device (CCD) image sensor. The camera 5 may be a network camera such as an Internet protocol (IP) camera, or may be a general-purpose digital video camera or digital camera with a communication function. Alternatively, the camera 5 may be a camera integrated with the display apparatus 20 and built into a computer, for example, a tablet terminal. The camera 5 has, for example, a wireless local area network (LAN) communication function, and is connected to an information processing apparatus 100 via a relay apparatus (not illustrated) such as a router of a communication network 3.

The camera 5 captures an image of a face of the user 30 who is about to pass through the passage 16 of the ticket gate machine 10, and transmits the captured image to the information processing apparatus 100. The information processing apparatus 100 performs authentication processing by use of the face image of the user 30.

The camera 5 may include a mechanism for adjusting and controlling focusing, exposure compensation, an aperture value, a shutter speed, ISO sensitivity, and the like, in order to heighten image quality of a face image capturing a person and acquire an optimal feature value for face authentication, or may be controlled automatically or by remote control or the like from an operating terminal (not illustrated) of a manager or the like.

An image generated by the camera 5 is preferably captured in real time, and transmitted to the information processing apparatus 100. However, an image transmitted to the information processing apparatus 100 may not be directly transmitted from the camera 5, and may be an image delayed for a predetermined time. An image captured by the camera 5 may be temporarily stored in another storage apparatus, and the information processing apparatus 100 may read the image from the storage apparatus sequentially or at predetermined intervals. Further, an image transmitted to the information processing apparatus 100 may be a moving image, may be a frame image for each predetermined interval, or may be a still image.

The display apparatus 20 is a liquid crystal display, an organic electro-luminescence (EL) display, or the like. The display apparatus 20 may display a face image capturing, by the camera 5, the user 30 who is about to be passed through by the ticket gate machine 10, and display a message for the user 30 or the like.

Note that, the camera 5 and the display apparatus 20 may be provided within a housing (not illustrated), and an installation method is not particularly limited.

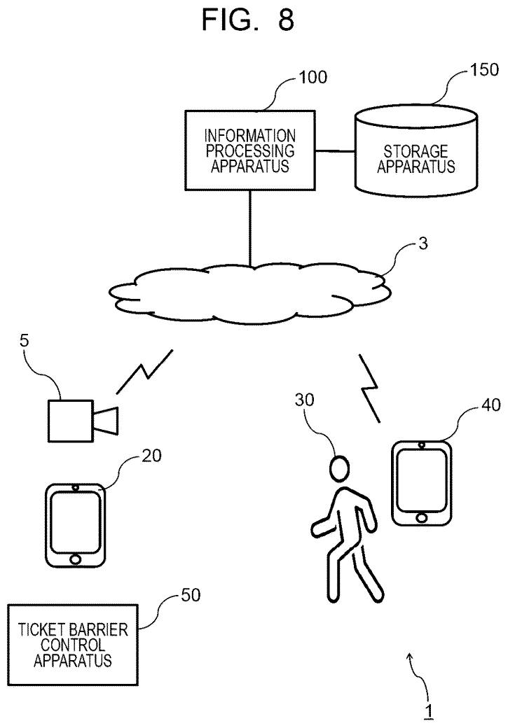

FIG. 8 is a diagram conceptually illustrating a system configuration of a ticket checking system 1 according to the example embodiment.

The ticket checking system 1 includes the information processing apparatus 100, the camera 5, the display apparatus 20, the ticket barrier control apparatus 50, and a user terminal 40. The camera 5 and the display apparatus 20 have been described by use of FIG. 7. The ticket barrier control apparatus 50 controls opening and closing of the gate 14 of the ticket gate machine 10. The user terminal 40 is a terminal owned by the user 30 who utilizes transportation. However, the user terminal 40 may be a terminal lent to the user 30.

The user terminal 40 is, for example, a computer such as a smartphone, a tablet terminal, or a personal computer.

The information processing apparatus 100 includes a storage apparatus 150. The storage apparatus 150 may be provided within the information processing apparatus 100, or may be provided externally. That is to say, the storage apparatus 150 may be hardware integrated with the information processing apparatus 100, or may be hardware separate from the information processing apparatus 100.

Moreover, the information processing apparatus 100 is a server computer or a personal computer, and may be a combination of a plurality of computers. For example, a computer installed at each station of transportation, and a computer installed at a center that manages a plurality of stations can be included. Moreover, the storage apparatus 150 may similarly be implemented by a plurality of storage apparatuses. The storage apparatus 150 may be a plurality of storage apparatuses included in each of a plurality of computers. Hereinafter, the storage apparatus 150 is used as a general term for the storage apparatuses.

The user 30 preliminarily performs utilization registration for a service that the ticket checking system 1 according to the example embodiment provides to the user 30, and, thereby, the user 30 becomes able to utilize the service.

For example, the user 30 can utilize the ticket checking system 1 by installing and starting a predetermined application on the user terminal 40 of the user 30, accessing a predetermined website by use of a browser, and the like. Before starting utilization of a service, the user 30 preliminarily registers authentication information utilized for face authentication for identification as account information.

Herein, a face image acquired by capturing the user 30 is registered in a database (the storage apparatus 150) as authentication information. However, information to be registered in the database as authentication information may not be a face image itself, but may be feature information extracted from a face image, or may be both a face image and the feature information.

For example, a booth for registering a face image may be provided inside area of a station or the like, and a registration apparatus (not illustrated) in the booth may capture a face image of the user 30, and perform a registration procedure. Alternatively, an application or a website for registration may be accessed by use of the user terminal 40 of the user 30, a face image of the user 30 may be captured by use of a camera of the user terminal 40, and a registration procedure may be performed.

The feature information may be feature information of another piece of biological information other than a face. The biological information may include at least one of pieces of feature information such as an iris, a vein, an auricle, a fingerprint, a gait, a body built (a height, a shoulder width, a body height, a bone structure, and the like), and the like, or may be a combination of a plurality of pieces of characteristic information.

### Hardware Configuration Example

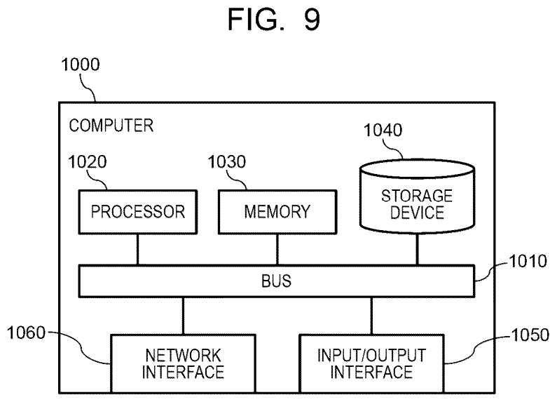

FIG. 9 is a block diagram illustrating a hardware configuration of a computer 1000 that implements the information processing apparatus 100. The display apparatus 20, the camera 5, the ticket barrier control apparatus 50, the user terminal 40, and the like in FIG. 8 are also implemented by the computer 1000. Moreover, the information processing apparatus 100 may be implemented by a plurality of the computers 1000, and the functions of the information processing apparatus 100 may be distributed to and executed by each of the computers 1000.

The computer 1000 includes a bus 1010, a processor 1020, a memory 1030, a storage device 1040, an input/output interface 1050, and a network interface 1060.

The bus 1010 is a data transmission path through which the processor 1020, the memory 1030, the storage device 1040, the input/output interface 1050, and the network interface 1060 transmit/receive data to/from each other. However, a method of mutually connecting the processor 1020 and the like is not limited to bus connection.

The processor 1020 is a processor implemented by a central processing unit (CPU), a graphics processing unit (GPU), or the like.

The memory 1030 is a main storage apparatus implemented by a random access memory (RAM) or the like.

The storage device 1040 is an auxiliary storage apparatus implemented by a hard disk drive (HDD), a solid state drive (SSD), a memory card, a read only memory (ROM), or the like. The storage device 1040 stores a program module that implements each function (e.g., a determination unit 102, a settlement processing unit 104, a transmission unit 106, a refund processing unit 108, an authentication unit 110, a gate control unit 120, and a decision unit 130, and a demand notification unit 112, a countermeasure processing unit 132, and the like described later) of the information processing apparatus 100. The processor 1020 reads each of the program modules onto the memory 1030, executes the read program module, and thereby implements each function corresponding to the program module. Moreover, the storage device 1040 may also store each piece of data in the storage apparatus 150 of the information processing apparatus 100.

The program module may be recorded on a medium. A medium that records the program module includes a non-transitory tangible medium usable by the computer 1000, and a program code readable by the computer 1000 (processor 1020) may be embedded in the medium.

The input/output interface 1050 is an interface for connecting the computer 1000 and various pieces of input/output equipment. The input/output interface 1050 also functions as a communication interface that performs near-field wireless communication such as Bluetooth (registered trademark) and near field communication (NFC).

The network interface 1060 is an interface for connecting the computer 1000 to a communication network. The communication network is, for example, a local area network (LAN) or a wide area network (WAN). A method of connecting the network interface 1060 to the communication network may be wireless connection or wired connection.

Then, the computer 1000 connects to necessary equipment (e.g., a display, a touch panel, an operation button, a speaker, and a microphone of the user terminal 40, and the like) via the input/output interface 1050 or the network interface 1060.

Each component of the information processing apparatus 100 according to each example embodiment in FIGS. 1, 3, and 5, and FIGS. 15, 19, 22, 24, and 27 described later is implemented by any combination of hardware and software of the computer 1000 in FIG. 9.

Then, it is appreciated by a person skilled in the art that there are a variety of modified examples of implementing methods and apparatuses. A functional block diagram illustrating the information processing apparatus 100 according to each example embodiment illustrates not a configuration on a hardware basis but a block on a logical function basis.

### Functional Configuration Example

A functional configuration example of the information processing apparatus 100 according to the example embodiment is described below by use of FIG. 1.

The information processing apparatus 100 according to the present example embodiment performs settlement processing of a fare, and confirms with the user 30 about utilization of transportation in a case where the user 30 for deposit balance payment has passed through the gate 14 of the ticket barrier control apparatus 50 by face authentication, or performs refund processing in a case where the user 30 does not approve of utilization of the transportation.

Note that, in the present example embodiment, the ticket gate machine 10 dedicated to the user 30 whose payment method of a fare is deposit balance payment, and the ticket gate machine 10 dedicated to the user 30 whose payment method of a fare is a commuter pass may be each installed separately. The information processing apparatus 100 according to the present example embodiment executes settlement processing of a fare for a user 30 who utilizes the ticket gate machine 10 dedicated to the user 30 whose payment method of a fare is deposit balance payment.

The information processing apparatus 100 includes the determination unit 102, the settlement processing unit 104, the transmission unit 106, and the refund processing unit 108.

The determination unit 102 determines a person (user 30) who has passed through the gate 14 of a ticket barrier (ticket gate machine 10) of transportation by face authentication.

As described above, face authentication is performed by collating feature information extracted from a face image of the user 30 captured with the camera 5 with the authentication information of the user 30 previously registered in a database. A person for whom a result of the collation is equal to or more than a threshold value can pass through the gate 14.

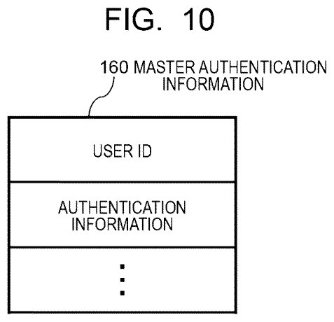

FIG. 10 is a diagram illustrating a data structure example of master authentication information 160.

The master authentication information 160 stores, regarding a plurality of users 30, identification information that uniquely identifies each of the users 30, and authentication information being feature information extracted from a face image of the user 30, in relation to each other. Master authentication information 160 is stored in the storage apparatus 150. The authentication information is feature information of a face, or at least one of pieces of other biological information (an iris, a vein, an auricle, a fingerprint, a gait, a body built (a height, a shoulder width, a body length, a bone structure, and the like)). Moreover, a face image of the user 30 may be related to and stored in the master authentication information 160.

A collation result (face authentication result) includes a score indicating a matching degree (or a similarity degree) between feature information extracted from a face image of the user 30 and previously registered authentication information of the user 30. The score may be indicated as, for example, a value of 0 to 100, 0 to 1, or the like.

A higher matching degree of a collation result more indicates that a person is the very user 30, and a lower matching degree more indicates that a person is a person other than the user 30. Thus, among at least one person (registrant) whose score indicating a collation result is equal to or more than a threshold value, a person (registrant) with the highest score is assessed to be the vary user 30, and can pass through the gate 14 as a person who is successful in authentication.

Herein, in a case where a value of a threshold value is heightened (made large), since whether a person is the person is strictly assessed, a success rate of authentication becomes low, and a rate of erroneous recognition in which another person is assessed to be the user 30 becomes low. On the other hand, in a case where a value of a threshold value is lowered (made small), assessment becomes loose, a success rate of authentication becomes high, and a rate of erroneous recognition in which another person is determined to be the user 30 becomes high.

In this way, by changing a value of a threshold value, a success rate of authentication and a rate of erroneous recognition can be adjusted. Particularly, in authentication processing at passage through the ticket gate machine 10 of transportation, a case where it is preferable that a passage ratio of the ticket gate machine 10 can be adjusted according to congestion status or the like of the user 30 of the transportation can be considered. This is because it is not preferable that heightening a threshold value and lowering a passage ratio during a time of commuting to work or school when the number of the users 30 is large has a possibility of encouraging congestion. Thus, a threshold value may be allowed to be changed from a setting menu of the information processing apparatus 100 or the like, according to each station of transportation, each location (ticket gate), a time period, and the like.

The settlement processing unit 104 performs settlement processing of a fare for the determined person. The settlement processing of a fare may be performed by a non-illustrated settlement apparatus. The settlement processing unit 104 instructs the settlement apparatus about settlement processing of a fare. A settlement apparatus may be an external system. The instruction of settlement processing includes identification information of the user 30, and information for determining a fare. The information for determining a fare may be the fare itself, or may be information of a getting-on station and a getting-off station of transportation at which the user 30 has passed through the ticket gate machine 10.

Timing at which decision of settlement processing is performed is exemplified below, but is not limited to thereto.
(1) After the user 30 passes through the gate 14 in order to get on transportation (e.g., a case where a fare is on a flat rate system, a case of a system in which a lowest fare is temporarily collected, and the like)
(2) After the user 30 passes through the gate 14 in order to get off transportation (a case of a system in which a fare is collected according to a utilization section, a case where additional fare payment is needed in such a case as getting on from within a utilization section of a commuter pass and then getting off outside the utilization section of the commuter pass, and the like)

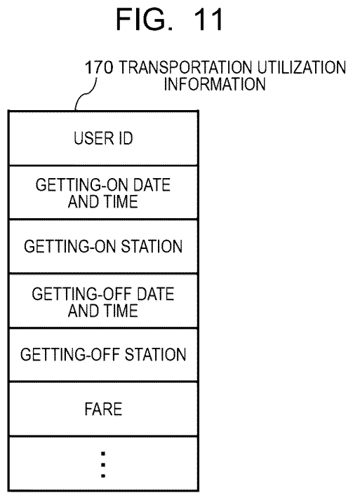

FIG. 11 is a diagram illustrating one example of means of transportation utilization information 170. The transportation utilization information 170 stores information indicating utilization details of transportation of the user 30. The transportation utilization information 170 is stored in the memory 1030 included in the user terminal 40 of the user 30, and also stored in the storage apparatus 150.

The transportation utilization information 170 includes, in relation to a user ID of the user 30, a getting-on date and time, a getting-on station, a getting-off date and time, a getting-off station, and a settled fare, as information relating to utilization of transportation. The getting-on station and the getting off station may include information that identifies transportation, and are not particularly limited as long as the getting-on station and the getting off station are information that can determine a station. In a case where the transportation utilization information 170 is stored in the memory 1030 of the user terminal 40, the transportation utilization information 170 may not include a user ID.

The user terminal 40 of the user 30 includes an IC card holding information relating to an amount of money (so-called electronic money) that has been previously charged for deposit balance payment. In the system, information relating to electronic money held in the IC card of the user terminal 40 of the user 30 is previously registered for settlement processing in order for the user 30 to pay a fare at utilization of transportation from the deposit balance.

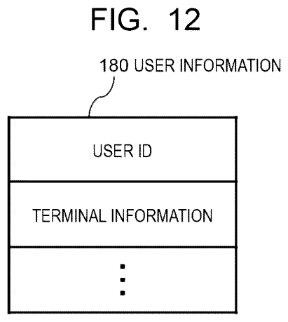

The transmission unit 106 transmits, to the user terminal 40 of the determined person, information indicating that the transportation has been utilized. FIG. 12 is a diagram illustrating a data structure example of user information 180. The user information 180 includes identification information (also referred to as user ID) of the user 30 and information (in the figure, indicated as terminal information) relating to the user terminal 40 of the user 30 in relation to each other. The terminal information includes, for example, information to be a destination for receiving a message from the information processing apparatus 100 at the user terminal 40 utilized by the user 30, and includes, for example, a mobile phone number to be destination information for a message of short message service (SMS), an email address, and the like. The message includes a uniform resource locator (URL) for causing the user terminal 40 to display a notification screen 200 that notifies of utilization of transportation described later.

In a case where an application of the user terminal 40 of the user 30 is registered, the transmission unit 106 may cause, via the application, the user terminal 40 to display information indicating that transportation has been utilized, by various notification methods, for example, various methods such as batch display, a banner display, a notification display on a standby screen, or the like, and display the notification screen 200 from the notification display.

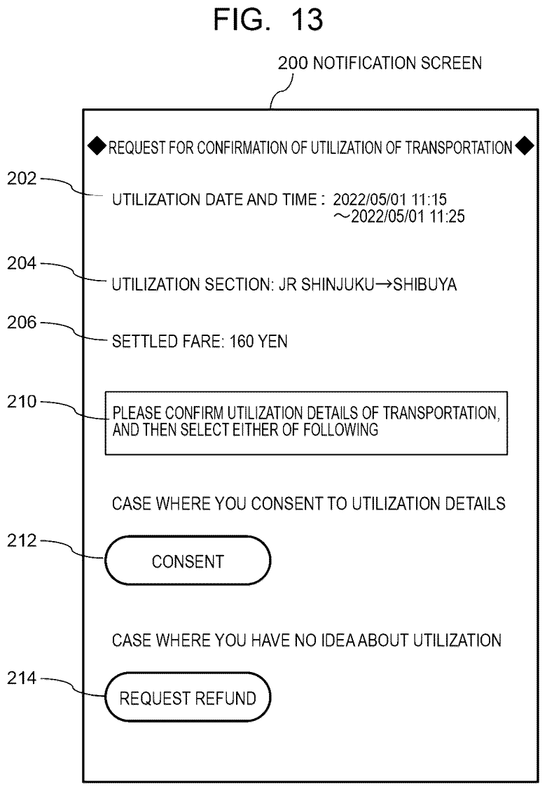

FIG. 13 is a diagram illustrating one example of the notification screen 200. The notification screen 200 includes a utilization date and time display unit 202 indicating a utilization date and time of transportation, a utilization section display unit 204 indicating a utilization section, and a fare display unit 206 indicating a settled fare. Further, the notification screen 200 includes a message display unit 210, a consent button 212, and a refund request button 214. The message display unit 210 displays a message prompting an answer of whether to consent to utilization details or request a refund after confirming the utilization details of the transportation. The consent button 212 is an operation button that the user 30 depresses in a case of consenting to the utilization details, and accepts consent to the utilization details in response to depression of the consent button 212. The refund request button 214 is an operation button that is depressed in a case where the user 30 does not consent to utilization details and requests a refund of a fare, and accepts a refund request in response to depression of the refund request button 214.

In a case where the refund processing unit 108 acquires predetermined information from a terminal, the refund processing unit 108 executes refund processing for a settled fare. Herein, the predetermined information is information indicating that transportation has not been utilized. That is to say, the user 30 can return, to the ticket checking system 1, information indicating that the user 30 has no idea about utilization of transportation, and can demand a refund of a fare that has been subjected to settlement processing.

### Operation Example

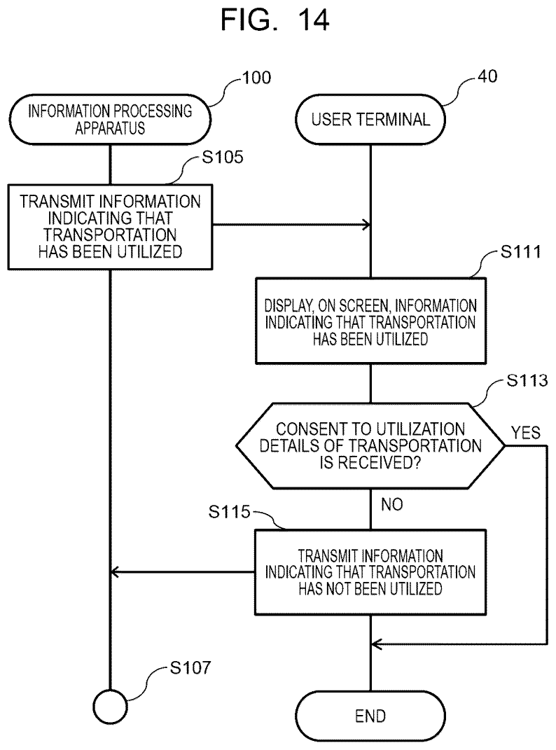

An operation example of the information processing apparatus 100 according to the example embodiment is described below by use of FIGS. 2 and 14. FIG. 14 is a flowchart illustrating a detailed example of operations of the information processing apparatus 100 and the user terminal 40 in step S105 of FIG. 2 in the ticket checking system 1 according to the example embodiment.

First, the determination unit 102 determines, by face authentication, a person who has passed through a gate of a ticket barrier of transportation (step S101 in FIG. 2). The settlement processing unit 104 performs settlement processing of a fare for the determined person (step S103 in FIG. 2). The transmission unit 106 transmits, to a terminal of the determined person, information indicating that the transportation has been utilized (step S105 in FIGS. 2 and 14).

As illustrated in FIG. 14, the user terminal 40 displays the notification screen 200 in FIG. 13 on a display, based on information received from the information processing apparatus 100 (step S111). In a case where the user 30 depresses the consent button 212, the user terminal 40 accepts consent to utilization details of transportation (YES in step S113), bypasses processing in step S115, and ends processing (e.g., closes the screen 200).

On the other hand, in a case where the user 30 depresses the refund request button 214, the user 30 does not consent to the utilization details of the transportation and requests a refund (NO in step S113), and, therefore, information indicating that the transportation has not been utilized is transmitted as predetermined information from the user terminal 40 to the information processing apparatus 100 (step S115).

In the information processing apparatus 100, since the refund processing unit 108 acquires, as predetermined information from a terminal, information indicating that the transportation has not been utilized (YES in step S107 in FIG. 2), and therefore executes refund processing for the settled fare for the person (step S109), and the present processing is ended.

Note that, as a determination criterion of not acquiring predetermined information in step S113 described above, not accepting depression of the consent button 212 in the notification screen 200 may be included in addition to accepting depression of the refund request button 214 in the notification screen 200.

Note that, in a case of the ticket gate machine 10 dedicated to the user 30 whose payment method of a fare is a commuter pass, the information processing apparatus 100 bypasses all of pieces of processing in steps S103 to S109 regarding the person determined in step S101 of FIG. 2.

As described above, according to the present example embodiment, the information processing apparatus 100 includes the determination unit 102, the settlement processing unit 104, the transmission unit 106, and the refund processing unit 108. The determination unit 102 determines, by face authentication, a person who has passed through the gate 14 of a ticket barrier of transportation. The settlement processing unit 104 performs settlement processing of a fare for the determined person. The transmission unit 106 transmits, to the user terminal 40 of the determined person, information indicating that the transportation has been utilized. In a case where the refund processing unit 108 acquires, from the user terminal 40, predetermined information indicating that the transportation has been not utilized, the refund processing unit 108 executes refund processing for a settled fare.

The configuration can solve a problem of an increase in an incidence of erroneous charging of a fare and a reduction in a passage ratio of a gate in a ticket barrier utilizing a face authentication gate. Specifically, a mechanism that appropriately performs refund processing in a case where erroneous charging of a fare occurs in a ticket barrier of face authentication of transportation without reducing a gate passage ratio and impairing convenience at utilization of the transportation is provided.

### Second Example Embodiment

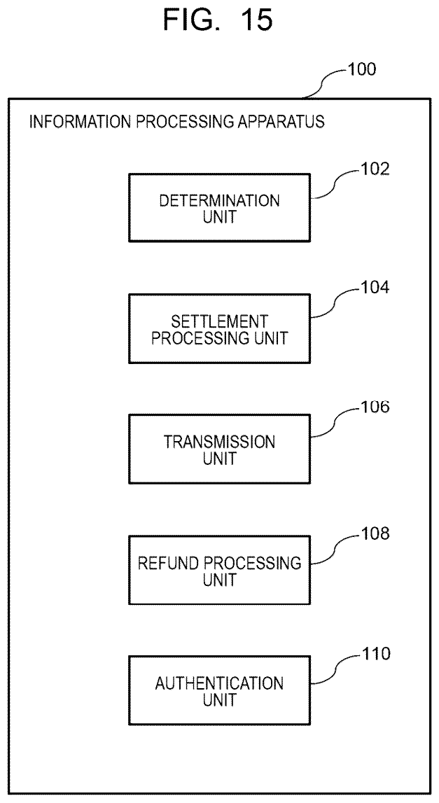

FIG. 15 is a functional block diagram illustrating a functional configuration example of an information processing apparatus 100 according to the example embodiment.

The present example embodiment is similar to the example embodiment described above, except for including a configuration that performs processing of narrowing down a person for whom face authentication is performed by use of position information of a user 30. The present example embodiment includes the same configuration as the information processing apparatus 100 in FIG. 1, and further includes an authentication unit 110. However, components according to the present example embodiment may be combined with at least one of components according to another example embodiment to an extent that no contradiction occurs.

### Functional Configuration Example

The authentication unit 110 narrows down, by use of position information of the user 30 of transportation, a person for whom face authentication is to be performed, and performs face authentication on the narrowed-down person.

As described above, since the information processing apparatus 100 may be configured by a plurality of computers 1000, the authentication unit 110 may be implemented by the computer 1000 different from the information processing apparatus 100 in FIG. 2.

In face authentication processing by the authentication unit 110, a person being an authentication target is collated with authentication information of a large number of registrants (so-called 1:N collation processing), and, among at least one person (registrant) whose score is equal to or more than a threshold value, a person (registrant) whose score is the highest is determined to be the very user 30. Thus, by narrowing down the number of registrants (N persons) to be collation targets, authentication accuracy can be improved.

The authentication unit 110 acquires position information of a user terminal 40 of the user 30. For example, communication of the user terminal 40 by near field communication (NFC) such as Bluetooth (registered trademark), wireless fidelity (Wi-Fi), or the like is detected, thereby, the user terminal 40 existing within a communication range can be determined, and the user 30 of the user terminal 40 can be determined. Alternatively, by acquiring position information acquired by a global positioning system (GPS) reception function of the user terminal 40, the determination unit 102 can determine that the user terminal 40 exists within a predetermined range.

By previously starting an application of the user terminal 40, the user 30 becomes able to provide the position information to the information processing apparatus 100. For example, the user 30 may be prompted to start an application by causing the user terminal 40 to display a message prompting utilization of a predetermined service inside area of a station and start of the application. As one example, it can be considered to perform grant of an incentive (a point, a fare discount, or the like) that can be utilized for a service inside area of a station by performing a check-in procedure at a station or a store inside area of the station.

After determining the user 30 of the user terminal 40 existing within the communication range, the authentication unit 110 reads authentication information of the user 30 from master authentication information 160, and performs collation processing.

Moreover, in addition to a database of a registrant for whom the authentication unit 110 performs collation processing, the ticket checking system 1 can further include a database in which authentication information of a person whose passage through a ticket barrier is not permitted is registered. In a case where a collation result that the person is a person registered in the database is acquired, the person may be prohibited from passing through the gate 14.

### Operation Example

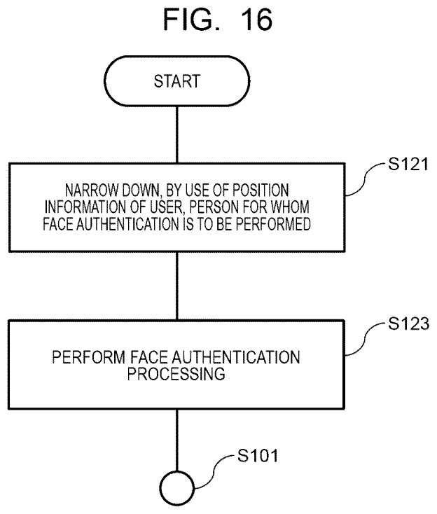

FIG. 16 is a flowchart illustrating an operation example of the information processing apparatus 100 according to the example embodiment. Processing in this figure is executed before step S101 in FIG. 2. The authentication unit 110 acquires position information of the user 30, and narrows down a person for whom face authentication is to be performed (step S121). Then, the authentication unit 110 performs face authentication processing on the narrowed-down person (step S123).

Specifically, for example, the authentication unit 110 acquires position information, together with a user ID of the user 30 from the user terminal 40 of at least one user 30 existing around a ticket barrier control apparatus 50. Then, each piece of authentication information related to the user ID of the user 30 is read from the master authentication information 160, and collated with feature information extracted from a face image of the user 30 captured by the camera 5, and face authentication is performed.

The user 30 who is successful in face authentication by the authentication unit 110 can pass through the gate 14 of the ticket barrier control apparatus 50. The determination unit 102 determines a person who has passed through the gate 14 of the ticket barrier control apparatus 50, by acquiring, from the authentication unit 110, the user ID of the user 30 who is successful in authentication (step S101 in FIG. 2). Subsequently, the information processing apparatus 100 operates in a procedure described in the flowchart of FIG. 2.

As described above, according to the present example embodiment, the information processing apparatus 100 includes the authentication unit 110. The authentication unit 110 narrows down, by use of position information of the user 30 of transportation, a person for whom face authentication is to be performed, and performs face authentication regarding the narrowed-down person.

In this way, since the information processing apparatus 100 according to the present example embodiment provides an effect similar to that according to the example embodiment described above, and can further narrow down, based on position information of a person to be an authentication target, a registrant for whom collation processing is performed, authentication accuracy can be improved. Since the number of times of collation processing can also be reduced, a processing load can also be reduced, and an authentication processing velocity can also be improved.

### Third Example Embodiment

The present example embodiment is similar to any of the example embodiments described above, except for including a configuration that previously stores information indicating presence or absence of commuter pass utilization of a user 30, and performs settlement processing by deposit balance payment in a case where commuter pass utilization is out of target. It is assumed that the present example embodiment includes the same configuration as the information processing apparatus 100 in FIG. 2, and description is given by use of FIG. 2. However, a component according to the present example embodiment may be combined with at least one of components according to an example embodiments different from the information processing apparatus 100 according to the example embodiment in FIG. 2 to an extent that no contradiction occurs.

In the present example embodiment, the ticket gate machine 10 utilizable by both the user 30 whose payment method of a fare is deposit balance payment and the user 30 whose payment method of a fare is a commuter pass can be used.

### Functional Configuration Example

Master authentication information (master face information) 160 used for face authentication or determination information linked to the master authentication information 160 is stored in a storage apparatus 150 in relation to presence or absence of commuter pass information of the person.

In a case where the commuter pass information of a person determined by face authentication is absent in the storage apparatus 150, or in a case where it is decided based on the commuter pass information that the getting-on of the person is outside a section of a commuter pass, a settlement processing unit 104 executes settlement processing of a fare.

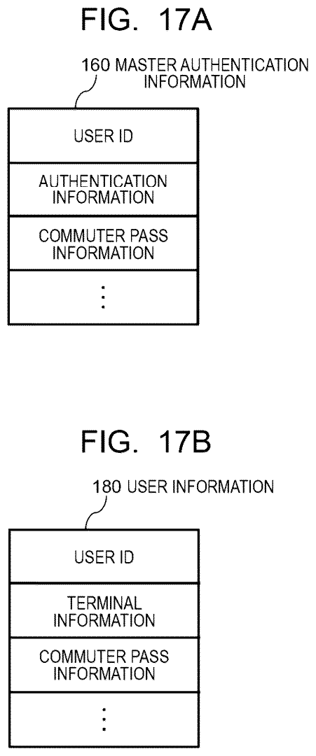

FIG. 17(a) and 17(b) are diagrams illustrating data structure examples of the master authentication information 160 and user information 180, respectively. In addition to the master authentication information 160 in FIG. 10, commuter pass information is further related to the master authentication information 160. In addition to the user information 180 in FIG. 12, commuter pass information is further related to the user information 180. The determination information linked to the master authentication information 160 is a user ID of the user information 180 in FIG. 12, and the user ID is linked to a user ID of the master authentication information 160 in FIG. 10. The user ID of the user information 180 and the user ID of the master authentication information 160 may be different identification information as long as the user IDs are linked to each other, or may be common identification information.

The commuter pass information includes at least one of a flag indicating presence or absence of a commuter pass, and information indicating a utilization section of the commuter pass. In addition thereto, the commuter pass information may include information such as a utilizable period, and, in a case also where a utilization date and time of transportation is outside the utilizable period, the settlement processing unit 104 also executes settlement processing of a fare.

For example, the master authentication information 160 is stored in a storage device 1040 (storage apparatus 150) of a computer 1000 installed at a center that manages a plurality of stations. The user information 180 is stored in storage device 1040 (storage apparatus 150) of the computer 1000 installed at each station. The commuter pass information may be stored in at least one of the master authentication information 160 and the user information 180.

In a case where commuter pass information of the user 30 is absent, or in a case where a flag indicating presence or absence of a commuter pass of the user 30 indicates that a commuter pass is absent, settlement processing is performed for a fare of the user 30 by deposit balance payment. Further, in a case where commuter pass information of the user 30 is present, but utilization of the transportation is outside a section of a commuter pass, based on information indicating a utilization section of a commuter pass included in the commuter pass information, settlement processing of a fare of the user 30 is performed by deposit balance payment.

In a case where commuter pass information of the user 30 is present and utilization of the transportation is within the section of the commuter pass, the settlement processing unit 104 does not perform settlement processing of a fare.

### Operation Example

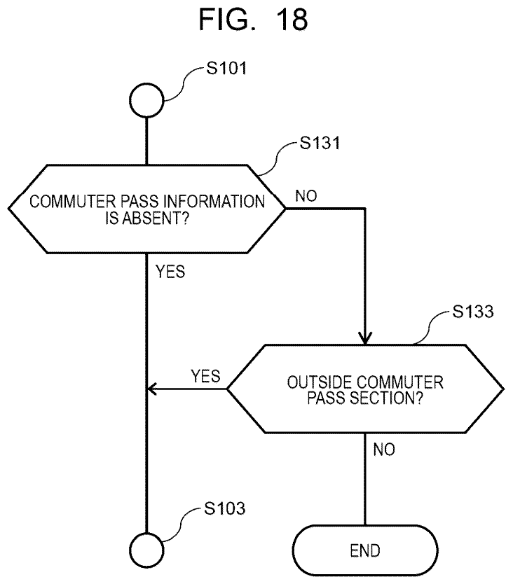

FIG. 18 is a flowchart illustrating an operation example of the information processing apparatus 100 according to the example embodiment.

The flow is executed after step S101 and before settlement processing of a fare in step S103. The settlement processing unit 104 refers to the master authentication information 160 or the transportation utilization information 170, and assesses presence or absence of commuter pass information of the user 30 determined in step S101 (step S131). In a case where commuter pass information is absent (YES in step S131), the flow proceeds to step S103 in FIG. 2, and the settlement processing unit 104 performs settlement processing of a fare for the user 30.

On the other hand, in a case where commuter pass information is present (NO in step S131), the settlement processing unit 104 assesses, based on information indicating a utilization section of a commuter pass included in the commuter pass information, whether utilization of the transportation is outside a section of a commuter pass (step S133). In a case of being outside the section of the commuter pass (YES in step S133), the flow proceeds to step S103 in FIG. 2, and the settlement processing unit 104 performs settlement processing of a fare for the user 30. In a case of being within the section of the commuter pass (NO in step S133), steps S103 and subsequent steps in FIG. 2 are bypassed, and the present processing is ended without performing the settlement processing of a fare.

As described above, according to the present example embodiment, the information processing apparatus 100 includes the settlement processing unit 104. The master authentication information (master face information) 160 used for face authentication or determination information linked to the master authentication information 160 is stored in the storage apparatus 150 in relation to presence or absence of commuter pass information of the person. In a case where the commuter pass information of a person determined by face authentication is absent in the storage apparatus 150, or in a case where it is decided based on the commuter pass information that getting-on of the person is outside a section of a commuter pass, the settlement processing unit 104 executes settlement processing of a fare.

In this way, the information processing apparatus 100 according to the present example embodiment provides an effect similar to that according to the example embodiment described above, further includes a configuration that previously registers commuter pass information of the user 30, thereby assesses presence or absence of utilization of a commuter pass, and can achieve a configuration that performs settlement processing of a fare in a case where a payment method is not a commuter pass, therefore, there is no longer a need to differentiate the ticket gate machine 10 according to a payment method, and the user 30 of either payment method becomes able to utilize the common ticket gate machine 10.

### Fourth Example Embodiment

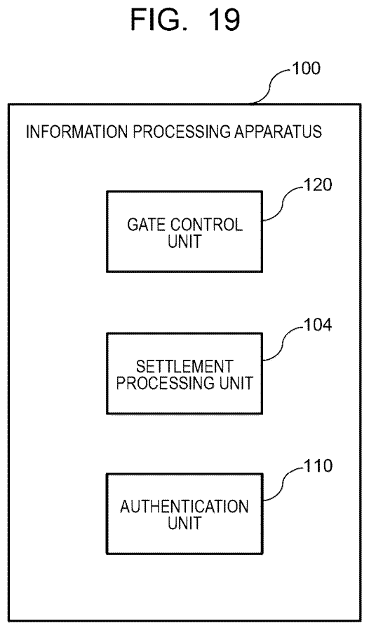

FIG. 19 is a functional block diagram illustrating a functional configuration example of an information processing apparatus 100 according to the example embodiment.

The information processing apparatus 100 according to the present example embodiment includes a configuration that changes a criterion of face authentication according to a payment method of a fare. Note that, the configuration according to the present example embodiment may be combined with at least one of the configurations according to other example embodiments to an extent that no contradiction occurs.

The present example embodiment describes a configuration that uses a ticket gate machine 10 utilizable by both a user 30 whose payment method of a fare is deposit balance payment and the user 30 whose payment method of a fare is a commuter pass.

The information processing apparatus 100 includes a gate control unit 120, a settlement processing unit 104, and an authentication unit 110.

The gate control unit 120 permits, in a case where a payment method of a fare of transportation is a commuter pass, passage of a person whose face authentication result satisfies a first criterion through a gate of a ticket barrier of transportation.

In a case where commuter pass information is present in master authentication information 160 or user information 180 described in the above example embodiment, in a case where a flag indicating presence or absence of a commuter pass included in commuter pass information indicates that a commuter pass is present, or in a case where the getting-on of the user 30 is within a section of a commuter pass, based on commuter pass information, the gate control unit 120 can assess that a payment method of a fare of transportation is a commuter pass.

The gate control unit 120 causes a ticket barrier control apparatus 50 to control opening and closing of a gate 14. In a case of permitting passage through the gate 14, the gate control unit 120 causes the ticket barrier control apparatus 50 to perform opening control of the gate 14. In a case of not permitting passage through the gate 14, the gate control unit 120 causes the ticket barrier control apparatus 50 to perform closing control of the gate 14.

The authentication unit 110 performs, regarding a person being an authentication target, collation processing between authentication information extracted from a face image of the person and authentication information of a plurality of registrants. The gate control unit 120 and the settlement processing unit 104 acquire a face authentication result from the authentication unit 110.

The settlement processing unit 104 performs, in a case where a payment method is deposit balance payment, settlement processing of a fare for a person whose face authentication result satisfies a second criterion being tighter than the first criterion.

In a case where it is not assessed to be the commuter pass utilization described above, in a case where commuter pass information is absent in the master authentication information 160 or the user information 180 described in the above example embodiment, in a case where a flag indicating presence or absence of a commuter pass included in commuter pass information indicates that a commuter pass is absent, or in a case where the getting-on of the user 30 is outside a section of a commuter pass, based on commuter pass information, the settlement processing unit 104 can assess that a payment method of a fare of transportation is deposit balance payment.

By causing the second criterion to be tighter than the first criterion, collation processing of face authentication in a case where a payment method is deposit balance payment can be performed with a tighter criterion than in a case where a payment method is a commuter pass. That is to say, in order to pass through the gate 14, it is necessary to match more or be more similar to registered authentication information in a case of deposit balance payment than a commuter pass. In a case of a commuter pass, the gate 14 can be passed through without even matching or being similar to registered authentication information, compared to deposit balance payment.

The first criterion is that a score indicating a face authentication result is equal to or more than a first threshold value, and the second criterion is being equal to or more than the first threshold value, and a person with the highest score among a plurality of persons who are successful in face authentication.

A score indicating a face authentication result is, for example, a value indicating a matching degree (or a similarity degree) in a case where authentication information extracted from a face image of the user 30 is collated with authentication information registered in the master authentication information 160. For example, a score with a larger numerical value indicates that registered authentication information matches more or is more similar to authentication information of the user 30.

The second criterion is that a score is equal to or more than a second threshold value being higher than the first threshold value.

### Operation Example

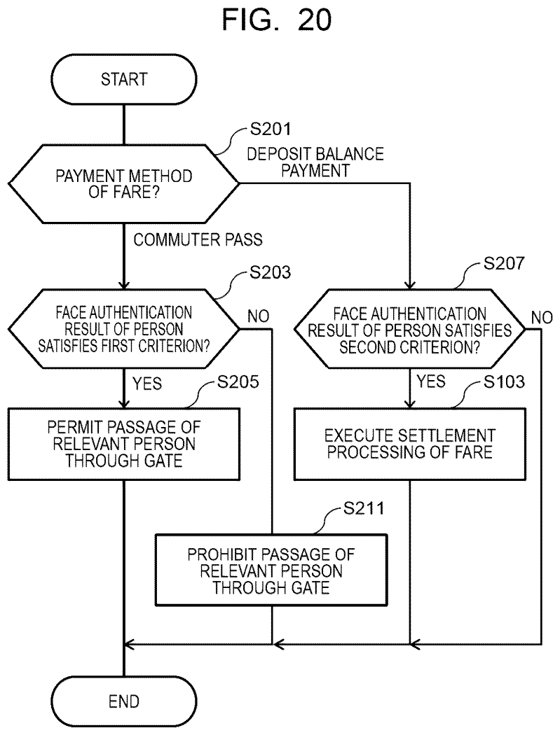

FIG. 20 is a flowchart illustrating an operation example of the information processing apparatus 100 according to the example embodiment.

In a case where commuter pass information is present in the master authentication information 160 or the user information 180, in a case where a flag indicating presence or absence of a commuter pass included in commuter pass information indicates that a commuter pass is absent, or in a case where the getting-on of the user 30 is within a section of a commuter pass, based on commuter pass information, the gate control unit 120 assesses that a payment method of a fare of transportation is a commuter pass (commuter pass in step S201), and the flow proceeds to step S203.

The gate control unit 120 acquires a face authentication result of the user 30 from the authentication unit 110, and decides whether the face authentication result satisfies the first criterion (step S203). Specifically, the gate control unit 120 decides whether a score indicating the face authentication result is equal to or more than the first threshold value. In a case where a score indicating the face authentication result is equal to or more than the first threshold value (YES in step S203), the gate control unit 120 permits, regarding the user 30, passage through the gate 14 of a ticket barrier of the transportation (step S205). Specifically, the gate control unit 120 causes the ticket barrier control apparatus 50 to perform opening control of the gate 14. On the other hand, in a case where a score indicating the face authentication result is not equal to or more than the first threshold value (NO in step S203), the gate control unit 120 prohibits, regarding the user 30, passage through the gate 14 of the ticket barrier of the transportation (step S211). Specifically, the gate control unit 120 causes the ticket barrier control apparatus 50 to perform closing control of the gate 14.

In a case where commuter pass information is absent in the master authentication information 160 or the user information 180, or in a case where the getting-on of the user 30 is outside a section of a commuter pass, based on commuter pass information, the settlement processing unit 104 assesses that a payment method is deposit balance payment (deposit balance payment in step S201), and the flow proceeds to step S207.

The settlement processing unit 104 acquires the face authentication result of the user 30 from the authentication unit 110, and decides whether the face authentication result satisfies a second criterion being tighter than the first criterion (step S207). Specifically, the settlement processing unit 104 decides whether a score indicating the face authentication result is equal to or more than the first threshold value. Further, the settlement processing unit 104 performs settlement processing of a fare for a person with the highest score among a plurality of persons whose score indicating a face authentication result is equal to or more than the first threshold value and who are successful in face authentication (YES in step S207) (step S103).

Alternatively, in a case where a score indicating the face authentication result is equal to or more than the second threshold value (YES in step S207), the settlement processing unit 104 performs settlement processing of a fare (step S103). In this instance, in a case where a score indicating the face authentication result is not equal to or more than the second threshold value (NO in step S207), step S103 is bypassed, and the settlement processing unit 104 ends the processing without performing settlement processing of a fare. However, in this case, regarding the user 30, the gate control unit 120 may proceed to step S211, and prohibit passage through the area 14 of the ticket barrier of the transportation. That is to say, the gate control unit 120 may cause the ticket barrier control apparatus 50 to perform closing control of the gate 14.

Moreover, the ticket gate machine 10 dedicated to the user 30 whose payment method of a fare is deposit balance payment, and the ticket gate machine 10 dedicated to the user 30 whose payment method of a fare is a commuter pass may be each installed separately. In this example, in a case of the ticket gate machine 10 dedicated to the user 30 whose payment method of a fare is deposit balance payment, the information processing apparatus 100 executes processing in steps S207 and S103 in FIG. 20. In a case of the ticket gate machine 10 dedicated to the user 30 whose payment method of a fare is a commuter pass, the information processing apparatus 100 executes processing in steps S203, S205, and S211 in FIG. 20.

As described above, according to the present example embodiment, the information processing apparatus 100 includes the gate control unit 120, the settlement processing unit 104, and the authentication unit 110. In a case where a payment method of a fare of transportation is a commuter pass, the gate control unit 120 permits passage of a person whose face authentication result satisfies the first criterion through a gate of a ticket barrier of transportation. In a case where a payment method is deposit balance payment, the settlement processing unit 104 performs settlement processing of a fare for a person whose face authentication result satisfies a second criterion being tighter than the first criterion.

The information processing apparatus 100 can solve a problem of an increase in an incidence of erroneous charging of a fare and a reduction in a passage ratio of a gate in a ticket barrier utilizing a face authentication gate.

More specifically, by changing a criterion of a face authentication result according to a payment method of a fare, the information processing apparatus 100 can solve such a problem that, in a case where a criterion of face authentication is tightened in a ticket barrier utilizing a face authentication gate, a rate of erroneous authentication is reduced, and an incidence of erroneous charging of a fare is reduced, but a passage ratio of a gate deteriorates, and convenience is impaired, whereas, in a case where a criterion of face authentication is loosened, a passage ratio of a gate improves, but a rate of erroneous authentication increases, and an incidence of erroneous charging of a fare rises.

Specifically, in a case where a payment method is a commuter pass, a passage ratio of a gate can be improved by setting an authentication criterion to be loose. In a case of a commuter pass, since a fare is not demanded, a fare is not erroneously collected from an account of another person, and erroneous charging does not occur. On the other hand, in a case where a payment method is deposit balance payment, a rate of erroneously collecting a fare from an account of another person can be reduced by setting an authentication criterion to be tight.

### Fifth Example Embodiment

An information processing apparatus 100 according to the present example embodiment includes a configuration that assesses a payment method of a fare, and performs settlement processing according to a payment method. Herein, description is given by use of FIG. 5. Note that, the configuration according to the present example embodiment may be combined with at least one of the configurations according to other example embodiments to an extent that no contradiction occurs.

The information processing apparatus 100 includes a decision unit 130, an authentication unit 110, a gate control unit 120, and a settlement processing unit 104.

The decision unit 130 decides whether a payment method of a fare by a user of transportation is a commuter pass or deposit balance payment.

In a case where master authentication information 160 or user information 180 described in the above example embodiment includes commuter pass information, in a case where a flag indicating presence or absence of a commuter pass included in commuter pass information indicates that a commuter pass is present, or in a case where the getting-on of a user 30 is within a section of a commuter pass, based on commuter pass information, the decision unit 130 can assess that a payment method of a fare of transportation is a commuter pass.

Moreover, in a case where it is not assessed to be the commuter pass utilization described above, in a case where commuter pass information is absent in the master authentication information 160 or the user information 180 described in the above example embodiment, in a case where a flag indicating presence or absence of a commuter pass included in commuter pass information indicates that a commuter pass is absent, or in a case where the getting-on of the user 30 is outside a section of a commuter pass, based on commuter pass information, the decision unit 130 can assess that a payment method of a fare of transportation is deposit balance payment.

The authentication unit 110 sets a threshold value for face authentication according to the decided payment method, and performs face authentication of the user by use of the threshold value. Regarding a person being an authentication target, collation processing between authentication information extracted from a face image of the person and authentication information of a plurality of registrants is performed. A person whose score indicating a collation result (face authentication result) is equal to or more than a threshold value is successful in face authentication.

For example, the authentication unit 110 sets a first threshold value in a case where a payment method is a commuter pass, and sets a second threshold value higher than the first threshold value in a case where a payment method is deposit balance payment.

In a case where a payment method is a commuter pass, the gate control unit 120 permits passage of the user through a gate of a ticket barrier of transportation when face authentication is successful. That is to say, in a case where a payment method is a commuter pass, and in a case where a score indicating a face authentication result is equal to or more than a first threshold value, face authentication is successful, passage of the user 30 through a gate 14 is permitted. Specifically, the gate control unit 120 causes the ticket barrier control apparatus 50 to perform opening control of the gate 14.

In a case where a score indicating a face authentication result is not equal to or more than the first threshold value, face authentication is unsuccessful, and passage of the user 30 through a gate 14 is not permitted. Specifically, the gate control unit 120 causes the ticket barrier control apparatus 50 to perform closing control of the gate 14.

In a case where a payment method is deposit balance payment, the settlement processing unit 104 performs settlement processing of a fare for the user 30 who is successful in face authentication. Note that, in a case where a payment method is a commuter pass, the settlement processing unit 104 does not perform settlement processing of a fare.

### Operation Example

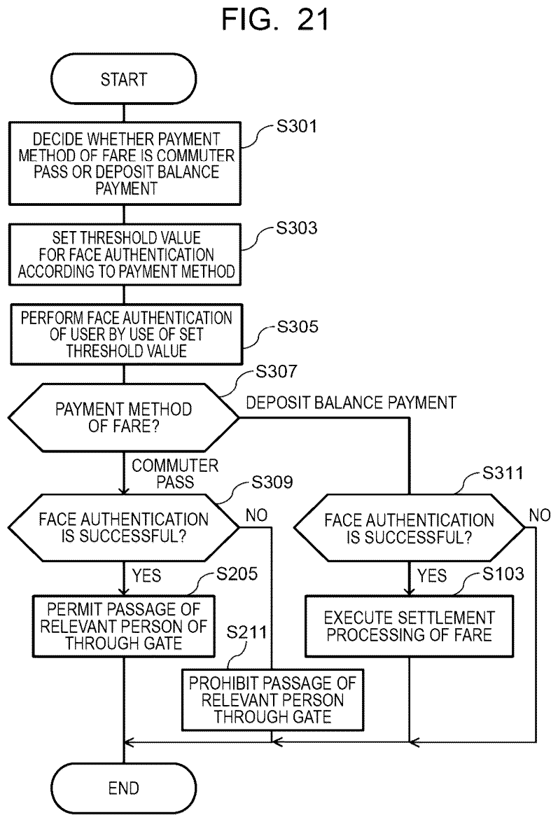

FIG. 21 is a flowchart illustrating an operation example of the information processing apparatus 100 according to the example embodiment.

The decision unit 130 decides whether a payment method of a fare by a user of transportation is a commuter pass or deposit balance payment (step S301).

Specifically, in a case where commuter pass information is present in the master authentication information 160 or the user information 180, in a case where a flag indicating presence or absence of a commuter pass included in commuter pass information indicates that a commuter pass is absent, or in a case where the getting-on of the user 30 is within a section of a commuter pass, based on commuter pass information, the decision unit 130 decides that a payment method of a fare of transportation is a commuter pass. In a case where commuter pass information is absent in the master authentication information 160 or user information 180, in a case where a flag indicating presence or absence of a commuter pass included in commuter pass information indicates that a commuter pass is absent, or in a case where the getting-on of the user 30 is outside a section of a commuter pass, based on commuter pass information, the decision unit 130 decides that a payment method of a fare of transportation is deposit balance payment.

The authentication unit 110 sets a threshold value for face authentication according to the decided payment method (step S303), and performs face authentication of the user 30 by use of the threshold value (step S305).

The authentication unit 110 sets a first threshold value in a case where a payment method is a commuter pass, and sets a second threshold value higher than the first threshold value in a case where a payment method is deposit balance payment. The authentication unit 110 performs, regarding a person being an authentication target, collation processing between authentication information extracted from a face image of the person and authentication information of a plurality of registrants. A person whose score indicating the collation result (face authentication result) is equal to or more than a threshold value is successful in face authentication.

In a case where a payment method is a commuter pass (commuter pass in step S307), the gate control unit 120 permits passage of the user 30 through the gate 14 of transportation in a case where the face authentication is successful, that is to say, in a case where a score indicating a face authentication result is equal to or more than the first threshold value (YES in step S309) (step S205). Specifically, the gate control unit 120 causes the ticket barrier control apparatus 50 to perform opening control of the gate 14. On the other hand, in a case where face authentication is unsuccessful, that is to say, in a case where a score indicating a face authentication result is not equal to or more than the first threshold value (NO in step S309), passage of the user 30 through the gate 14 of a ticket barrier of transportation is not permitted (step S211). Specifically, the gate control unit 120 causes the ticket barrier control apparatus 50 to perform closing control of the gate 14.

In a case where a payment method is deposit balance payment (deposit balance payment in step S307), the settlement processing unit 104 performs settlement processing of a fare (step S103) for the user 30 who is successful in face authentication, that is say, the user 30 whose score indicating a face authentication result is equal to or more than the second threshold value (YES in step S311). In this instance, in a case of the user 30 who is not successful in face authentication, that is to say, in a case where the score indicating the face authentication result is not equal to or more than the second threshold value (NO in step S311), step S103 is bypassed, and the settlement processing unit 104 ends the processing without performing settlement processing. However, in this case, regarding the user 30, the gate control unit 120 may proceed to step S211, and prohibit passage through the area 14 of the ticket barrier of the transportation. That is to say, the gate control unit 120 may cause the ticket barrier control apparatus 50 to perform closing control of the gate 14.

Moreover, a ticket gate machine 10 dedicated to the user 30 whose payment method of a fare is deposit balance payment, and the ticket gate machine 10 dedicated to the user 30 whose payment method of a fare is a commuter pass may be each installed separately. In this example, in a case of the ticket gate machine 10 dedicated to the user 30 whose payment method of a fare is deposit balance payment, the information processing apparatus 100 sets a second threshold value as a threshold value for face authentication. Then, the information processing apparatus 100 executes processing in steps S305 and S311 to S103 in FIG. 21. In a case of the ticket gate machine 10 dedicated to the user 30 whose payment method of a fare is a commuter pass, the information processing apparatus 100 sets a first threshold value as a threshold value for face authentication. Then, the information processing apparatus 100 executes processing in steps S305, S309, S205, and S211 in FIG. 21.

As described above, according to the present example embodiment, the information processing apparatus 100 includes the decision unit 130, the authentication unit 110, the gate control unit 120, and the settlement processing unit 104. The gate control unit 120 decides whether a payment method of a fare by a user of transportation is a commuter pass or deposit balance payment. The authentication unit 110 sets a threshold value for face authentication according to the decided payment method, and performs face authentication of the user by use of the threshold value. In a case where a payment method is a commuter pass, the gate control unit 120 permits passage of the user through a gate of a ticket barrier of the transportation in a case where face authentication is successful. In a case where a payment method is deposit balance payment, the settlement processing unit 104 performs settlement processing for the user who is successful in face authentication.

The information processing apparatus 100 can solve a problem of an increase in an incidence of erroneous charging of a fare and a reduction in a passage ratio of a gate in a ticket barrier utilizing a face authentication gate.

More specifically, by setting a threshold value for face authentication according to a payment method of a fare, the information processing apparatus 100 can solve such a problem that, in a case where a criterion of face authentication is tightened in a ticket barrier utilizing a face authentication gate, a rate of erroneous authentication is reduced, and an incidence of erroneous charging of a fare is reduced, but a passage ratio of a gate deteriorates, and convenience is impaired, whereas, in a case where a criterion of face authentication is loosened, a passage ratio of a gate improves, but a rate of erroneous authentication increases, and an incidence of erroneous charging of a fare rises.

Specifically, in a case where a payment method is a commuter pass, settlement processing of a fare is not performed when face authentication is successful, and, therefore, a fare is not erroneously collected from an account of another person, and erroneous charging does not occur. In a case where a payment method is deposit balance payment, settlement processing of a fare is performed for the user 30 who is successful in face authentication, and, therefore, a rate of erroneously collecting a fare from an account of another person can be reduced.

Further, since a configuration that decides a payment method of the user 30 is provided, there is no longer a need to differentiate the ticket gate machine 10 according to a payment method, and the user 30 of either payment method becomes able to utilize the common ticket gate machine 10.

### Sixth Example Embodiment

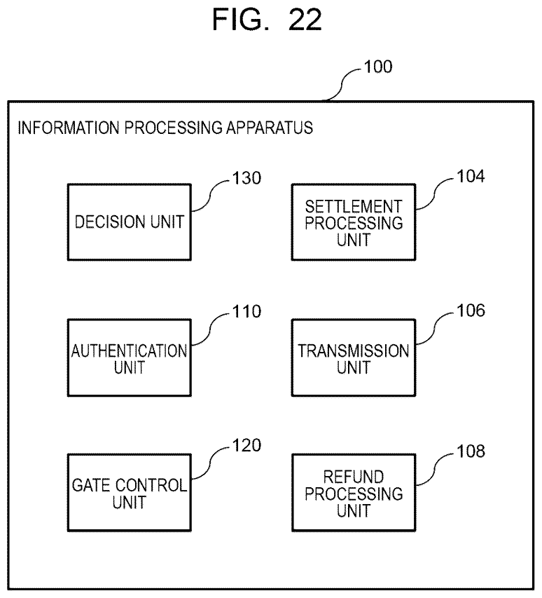

FIG. 22 is a functional block diagram illustrating a functional configuration example of an information processing apparatus 100 according to an example embodiment.

The present example embodiment includes a configuration that combines a transmission unit 106 and a refund processing unit 108 of the information processing apparatus 100 in FIG. 2 according to the first example embodiment with a configuration of the information processing apparatus 100 in FIG. 5 according to the fifth example embodiment. However, the configuration according to the present example embodiment may be combined with at least one of configurations according to example embodiments other than the first example embodiment to an extent that no contradiction occurs.

In the present example embodiment, a configuration that uses a ticket gate machine 10 utilizable by both a user 30 whose payment method of a fare is deposit balance payment and the user 30 whose payment method of a fare is a commuter pass is described.

The information processing apparatus 100 includes a decision unit 130, an authentication unit 110, a gate control unit 120, a settlement processing unit 104, a transmission unit 106, and a refund processing unit 108.

In a case where a payment method of a fare is deposit balance payment, the settlement processing unit 104 performs settlement processing of the fare after passage through a gate 14.

The transmission unit 106 transmits information indicating that transportation has been utilized, to a user terminal 40 of a person for whom settlement processing has been performed. In a case where the refund processing unit 108 acquires predetermined information from the user terminal 40, the refund processing unit 108 executes refund processing for the settled fare.

The predetermined information indicates that the transportation has not been utilized.

### Operation Example

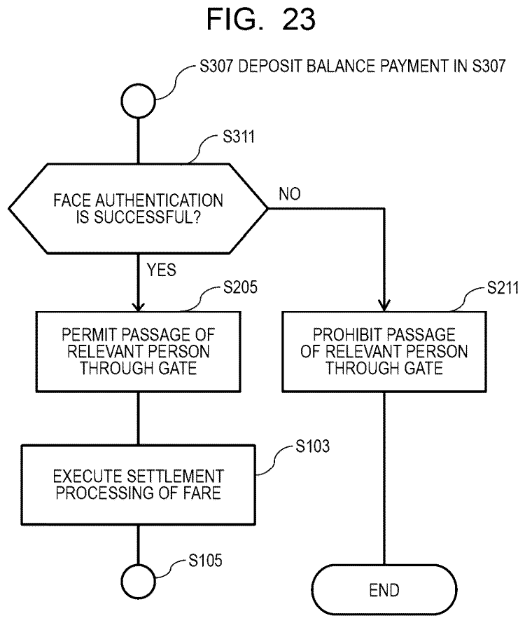

FIG. 23 is a flowchart illustrating an operation example of the information processing apparatus 100 according to the example embodiment. Description is given below by use of FIGS. 23, 21, 2, and 14.

A flow in FIG. 23 is executed after it is decided in step S307 of a flowchart in FIG. 21 according to the above example embodiment that a payment method is deposit balance payment.

First, in FIG. 21, the decision unit 130 decides whether a payment method of a fare by a user of transportation is a commuter pass or deposit balance payment (step S301). The authentication unit 110 sets a threshold value for face authentication according to the decided payment method (step S303), and performs face authentication of the user 30 by use of the threshold value (step S305).

The authentication unit 110 sets a first threshold value in a case where a payment method is a commuter pass, and sets a second threshold value higher than the first threshold value in a case where a payment method is deposit balance payment. Regarding a person being an authentication target, the authentication unit 110 performs collation processing between authentication information extracted from a face image of the person and authentication information of a plurality of registrants. A person whose score indicating the collation result (face authentication result) is equal to or more than a threshold value is successful in face authentication.

In a case where a payment method is deposit balance payment (deposit balance payment in step S307), the settlement processing unit 104 permits, for the user 30 who is successful in face authentication, that is to say, the user 30 whose score indicating a face authentication result is equal to or more than the second threshold value (YES in step S311), passage through the gate 14 of a ticket barrier of transportation (step S205). Specifically, the gate control unit 120 causes a ticket barrier control apparatus 50 to perform opening control of the gate 14. Thereby, the user 30 can pass through the gate 14. The settlement processing unit 104 performs settlement processing of a fare of the user 30 who has passed through the gate 14 (step S103). Then, the flow proceeds to step S105 in FIG. 2.

The transmission unit 106 transmits, to the user terminal 40 of the user 30 who has passed through the gate 14, information indicating that the transportation has been utilized (step S105). In the processing of step S105, as illustrated in FIG. 14 described above, the user terminal 40 displays a notification screen 200 in FIG. 13 on a display, based on the information received from the information processing apparatus 100 (step S111). In a case where the user 30 depresses a consent button 212, the user terminal 40 accepts consent to utilization details of transportation (YES in step S113), bypasses processing in step S115, and ends processing (e.g., closes the screen 200).

On the other hand, in a case where the user 30 depresses a refund request button 214, the user 30 does not consent to the utilization details of the transportation and requests a refund (NO in step S113), and, therefore, information indicating that the transportation has not been utilized is transmitted as predetermined information from the user terminal 40 to the information processing apparatus 100 (step S115).

Returning to FIG. 2, in a case where the refund processing unit 108 acquires predetermined information from the user terminal 40 (YES in step S107), that is to say, a person (user 30) being an owner of the user terminal 40 that has received the information indicating that the transportation has been utilized returns information indicating that the transportation has not been utilized, the refund processing unit 108 executes refund processing for the settled fare for the person (step S109), and ends the present processing.

On the other hand, in a case of the user 30 who is not successful in face authentication, that is to say, in a case where a score indicating a face authentication result is not equal to or more than the second threshold value (NO in step S311), the gate control unit 120 prohibits passage through the gate 14 of the ticket barrier of the transportation (step S211). That is to say, the gate control unit 120 causes the ticket barrier control apparatus 50 to perform closing control of the gate 14. Thereby, the user 30 cannot pass through the gate 14. Thus, processing in steps S103 and subsequent steps (e.g., settlement processing of a fare, transmission processing of predetermined information, and the like) is bypassed, and the present processing is ended.

Moreover, the ticket gate machine 10 dedicated to the user 30 whose payment method of a fare is deposit balance payment, and the ticket gate machine 10 dedicated to the user 30 whose payment method of a fare is a commuter pass may be each installed separately. In this example, in a case of the ticket gate machine 10 dedicated to the user 30 whose payment method of a fare is deposit balance payment, the information processing apparatus 100 sets a second threshold value as a threshold value for face authentication. Then, the information processing apparatus 100 executes processing in steps S305, S311, and S103 in FIG. 21. In a case of the ticket gate machine 10 dedicated to the user 30 whose payment method of a fare is a commuter pass, a first threshold value is set as a threshold value for face authentication. Then, the information processing apparatus 100 executes processing in steps S305, S309, S205, and S211 in FIG. 21.

As described above, according to the present example embodiment, the information processing apparatus 100 includes the decision unit 130, the authentication unit 110, the gate control unit 120, the settlement processing unit 104, the transmission unit 106, and the refund processing unit 108. In a case where a payment method of a fare is deposit balance payment, the settlement processing unit 104 performs settlement processing of the fare after passage through the gate 14. The transmission unit 106 transmits, to the user terminal 40 of a person for whom settlement processing has been performed, information indicating that the transportation has been utilized. In a case where the refund processing unit 108 acquires predetermined information from the user terminal 40, the refund processing unit 108 executes refund processing for the settled fare. The predetermined information indicates that the transportation has not been utilized.

In this way, the information processing apparatus 100 according to the present example embodiment provides an effect similar to that according to the example embodiment described above, and further provides a mechanism that appropriately performs refund processing in a case where erroneous charging of a fare occurs in a ticket barrier of a face authentication gate of transportation without reducing a gate passage ratio and impairing convenience at utilization of the transportation.

### Seventh Example Embodiment

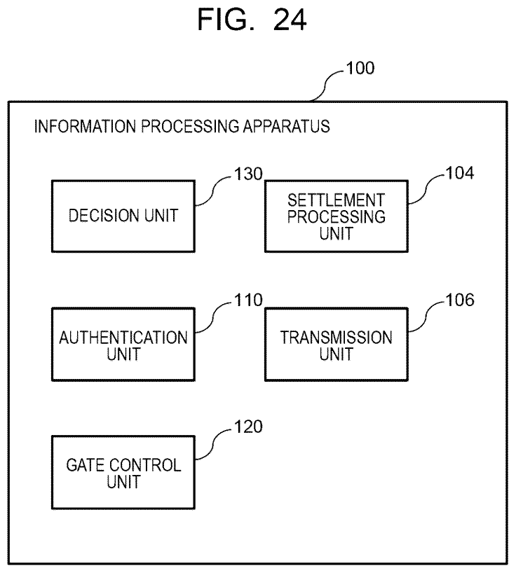

FIG. 24 is a functional block diagram illustrating a functional configuration example of an information processing apparatus 100 according to an example embodiment.

The present example embodiment is different from the sixth example embodiment described above in including a configuration that performs, in a case where a payment method of a fare is deposit balance payment, settlement processing of the fare after confirming with the user 30 that transportation has been utilized, that is to say, a configuration that enables deferred payment of a fare. Note that, the configuration according to the present example embodiment may be further combined with at least one of the configurations according to other example embodiments to an extent that no contradiction occurs.

### Functional Configuration Example

The information processing apparatus 100 includes a decision unit 130, an authentication unit 110, a gate control unit 120, a settlement processing unit 104, and a transmission unit 106 that are the same as those of the information processing apparatus 100 in FIG. 22.

In a case where a payment method of a fare is deposit balance payment, the transmission unit 106 transmits, to a user terminal 40 of a person of interest, information indicating that transportation has been utilized, after passage through the gate 14.

After acquiring predetermined information from the user terminal 40, the settlement processing unit 104 performs settlement processing of a fare.

The predetermined information includes information indicating that the user 30 agrees that the user 30 has utilized the transportation.

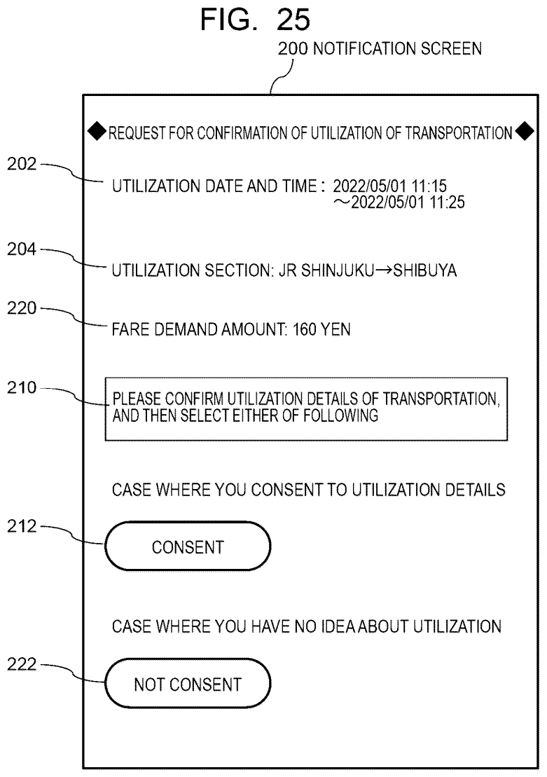

FIG. 25 is a diagram illustrating one example of a notification screen 200. The notification screen 200 includes a utilization date and time display unit 202, a utilization section display unit 204, a message display unit 210, and a consent button 212 that are the same as those of the notification screen 200 in FIG. 13, and also includes a fare demand amount display unit 220 and a reject button 222. The reject button 222 is an operation button that the user 30 depresses in a case where the user 30 does not consent to utilization details and rejects payment of a fare demand, and accepts that the user 30 does not agree to utilization of the transportation, in response to the depression of the reject button 222.

### Operation Example

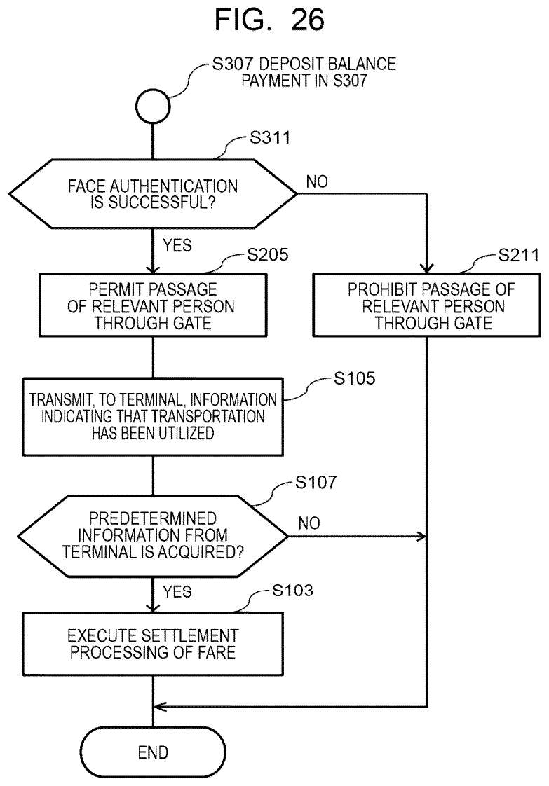

FIG. 26 is a flowchart illustrating an operation example of the information processing apparatus 100 according to the example embodiment.

A flow in FIG. 26 is executed after it is decided in step S307 of the flowchart in FIG. 21 according to the example embodiment described above that a payment method is deposit balance payment. Description is given below by use of FIGS. 24 and 14.

In a case where a payment method is deposit balance payment (deposit balance payment in step S307), the gate control unit 120 permits, for the user 30 who is successful in face authentication, that is to say, the user 30 whose score indicating a face authentication result is equal to or more than the second threshold value (YES in step S311), passage through the gate 14 of a ticket barrier of transportation (step S205). Specifically, the gate control unit 120 causes a ticket barrier control apparatus 50 to perform opening control of the gate 14.

The transmission unit 106 transmits, to the user terminal 40 of the person (user 30) who has passed through the gate 14, information indicating that the transportation has been utilized (step S105).

As illustrated in FIG. 14, the user terminal 40 causes a display to display the notification screen 200 in FIG. 25, based on the information received from the information processing apparatus 100 (step S111). In a case where the user 30 depresses a consent button 212, the user terminal 40 accepts consent to utilization details of transportation (YES in step S113), bypasses processing in step S115, and ends processing (e.g., closes the screen 200).

On the other hand, in a case where the user 30 depresses the reject button 222, the user 30 does not consent to the utilization details of the transportation and rejects payment of a fare demand (NO in step S113), and, therefore, information indicating that the transportation has not been utilized is transmitted as predetermined information from the user terminal 40 to the information processing apparatus 100 (step S115).

Returning to FIG. 26, the settlement processing unit 104 decides whether information indicating that transportation has been utilized is acquired from the user terminal 40 as predetermined information (step S107). In a case where the user 30 depresses the consent button 212 in the notification screen 200 on the user terminal 40, that is to say, in a case where information indicating that the transportation has been utilized is acquired from the user terminal 40 (YES at step S107), the settlement processing unit 104 performs settlement processing of a fare (step S103).

On the other hand, in a case where the predetermined information is not received (in a case where the user 30 has viewed the notification screen 200 but does not depress either the consent button 212 or the reject button 222), or in a case where the user 30 has depressed the refund request button 214 in the notification screen 200, that is to say, in a case where information indicating that the transportation has not been utilized is acquired from the user terminal 40 (NO in step S107), the settlement processing of a fare in step S103 is bypassed, and the present processing is ended.

Moreover, in a case of the user 30 who is not successful in face authentication, that is to say, in a case where a score indicating a face authentication result is not equal to or more than the second threshold value (NO in step S311), the gate control unit 120 prohibits passage through the gate 14 of the ticket barrier of the transportation (step S211). That is to say, the gate control unit 120 causes the ticket barrier control apparatus 50 to perform closing control of the gate 14. Thereby, the user 30 cannot pass through the gate 14. Then, processing relating to settlement processing is totally bypassed, and the present processing is ended.

As described above, according to the present example embodiment, the information processing apparatus 100 includes the decision unit 130, the authentication unit 110, the gate control unit 120, the settlement processing unit 104, and the transmission unit 106. In a case where a payment method is deposit balance payment, the transmission unit 106 transmits, to the user terminal 40 of a person of interest, information indicating that transportation has been utilized, after passage through the gate 14. After acquiring predetermined information from the user terminal 40, the settlement processing unit 104 performs settlement processing of a fare. The predetermined information includes information indicating that the user 30 agrees to a fact that the transportation has been utilized.

In this way, the information processing apparatus 100 according to the present example embodiment provides an effect similar to that according to the example embodiment described above, and further performs, in a case where a payment method is deposit balance payment, settlement processing of a fare only in a case information indicating that the user 30 agrees to a fact that the user 30 has utilized the transportation is returned, and, can therefore reduce an incidence of erroneous charging and eliminate trouble of refund processing.

### Eighth Example Embodiment

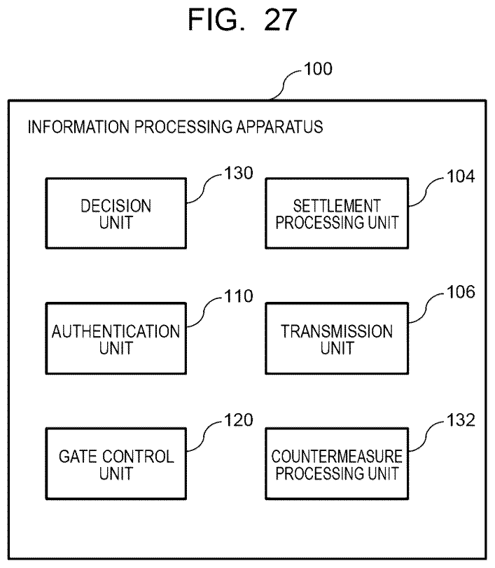

FIG. 27 is a functional block diagram illustrating a functional configuration example of an information processing apparatus 100 according to an example embodiment.

The present example embodiment is the same as the seventh example embodiment except for including a configuration that executes predetermined processing for a user 30 who does not receive predetermined information agreeing to utilization of transportation according to the seventh example embodiment equal to or more than a certain number of times. However, the configuration according to the present example embodiment may be combined with at least one of the configurations according to other example embodiments to an extent that no contradiction occurs.

### Functional Configuration Example

The information processing apparatus 100 includes the same configuration as the information processing apparatus 100 in FIG. 24, and further includes a countermeasure processing unit 132.

The countermeasure processing unit 132 executes predetermined processing for a person who does not perform settlement processing equal to or more than a certain number of times.

A person who does not perform settlement processing is a user 30 who does not acquire predetermined information indicating agreement to a fact that transportation has been utilized according to the seventh example embodiment. That is to say, the user 30 does not depress a consent button 212 on a notification screen 200.

The countermeasure processing unit 132 counts the number of times the user 30 of a user terminal 40 to which a transmission unit 106 has transmitted information indicating that transportation has been utilized does not depress the consent button 212 in the notification screen 200 displayed on the user terminal 40, or depresses a reject button 222, that is to say, the number of times the user does not receive predetermined information agreeing to a fact that transportation has been utilized, or does not consent to a fact that transportation has been utilized.

In a case where the counted number of times becomes equal to or more than a certain number of times, the countermeasure processing unit 132 executes predetermined processing for the user 30.

The predetermined processing includes processing for disabling use of an IC card of the registered user terminal 40 for deposit balance payment, processing of computing interest on an unpaid portion of a demanded fare, and adding the unpaid portion to a bill, processing of issuing a bill (information indicating a bank transfer destination may be included) requiring the user 30 to pay a fare, and the like. The countermeasure processing unit 132 may transmit the bill to the user terminal 40. For example, the countermeasure processing unit 132 may notify demand details of a bill on an application, may transmit a bill to the user terminal 40 by an email or an SMS message, or may transmit an email or an SMS message including a URL of a website including demand details.

### Operation Example

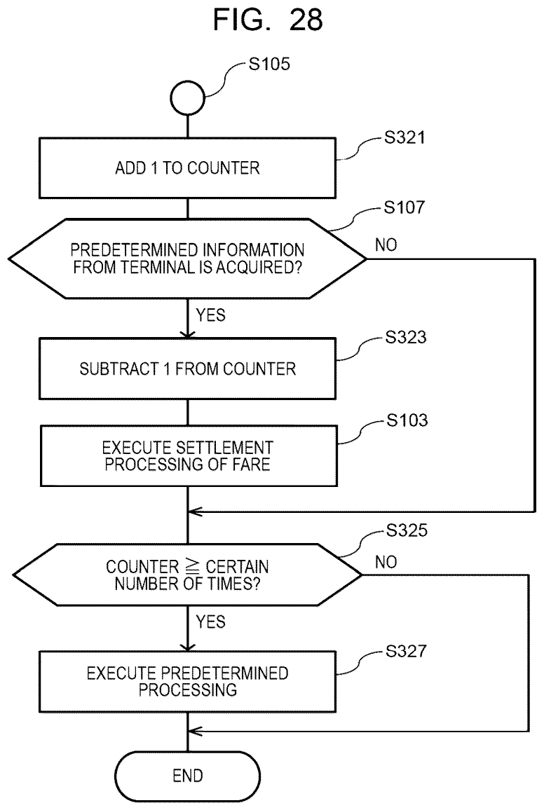

FIG. 28 is a flowchart illustrating an operation example of the information processing apparatus 100 according to the example embodiment.

The flow is executed after step S105 in FIG. 26. That is to say, after the transmission unit 106 transmits information indicating that transportation has been utilized to the user terminal 40 of a person (user 30) who has passed through a gate 14 (step S105), the countermeasure processing unit 132 adds 1 to the counter 30 (step S321).

The settlement processing unit 104 decides whether information indicating that transportation has been utilized is acquired from the user terminal 40 as predetermined information (step S107). In a case where the user 30 depresses the consent button 212 in the notification screen 200 on the user terminal 40, that is to say, in a case where information indicating that transportation has been utilized is acquired from the user terminal 40 (YES at step S107), the settlement processing unit 104 performs settlement processing of a fare (step S103).

Then, the countermeasure processing unit 132 subtracts 1 from a counter of the user 30 (step S323). On the other hand, in a case where the predetermined information is not received (in a case where the user 30 has viewed the notification screen 200 but does not depress either the consent button 212 or the reject button 222), or in a case where the user 30 has depressed the reject button 222 in the notification screen 200 on the user terminal 40, that is to say, in a case where information indicating that the transportation has not been utilized is acquired from the user terminal 40 (NO in step S107), the settlement processing of a fare in step S103 is bypassed, and the flow proceeds to step S325.

Then, the countermeasure processing unit 132 decides whether the counter of the user 30 is from equal to or more than a certain number of times (step S325). In a case where the counter is equal to or more than a certain number of times (YES in step S325), that is to say, in a case where utilization of transportation is not approved equal to or more than a certain number of times, the countermeasure processing unit 132 executes predetermined processing for the user 30 (step S327). In a case where the counter is not equal to or more than the certain number of times (NO in step S325), step S327 is bypassed, and the present processing is ended.

As described above, according to the present example embodiment, the information processing apparatus 100 further includes the countermeasure processing unit 132. The countermeasure processing unit 132 executes predetermined processing for a person who does not perform settlement processing equal to or more than a certain number of times.

In this way, the information processing apparatus 100 according to the present example embodiment provides an effect similar to that according to the example embodiment described above, and further enables some countermeasure to be taken to the user 30 whose number of times of not consenting to utilization of transportation is equal to or more than a certain number of times. Thereby, it becomes possible to take a countermeasure for the user 30 who fraudulently avoids payment of a fare, and, therefore, an effect of suppressing a fraudulent act can be expected.

The example embodiments according to the present invention have been described above with reference to the drawings, but are exemplifications of the present invention, and various configurations other than those described above can also be adopted.

For example, in the above-described example embodiment, deposit balance payment has been described by way of example as a payment method for a fare other than a commuter pass, but, for example, payment of a fare by transfer at a convenience store or the like is not excluded as another example. In this case, in a case of transmitting information indicating that transportation has been utilized, the transmission unit 106 transmits the information to the user terminal 40 including information necessary for transferring a fare of a bill. The user 30 can perform a transfer procedure of the fare, based on the information.

Moreover, although a plurality of processes (pieces of processing) are described in order in a plurality of flowcharts used in the above description, an execution order of processes executed in each example embodiment is not limited to the described order. In each example embodiment, an order of illustrated processes can be changed to an extent that causes no problem in terms of content. Moreover, the example embodiments described above can be combined to an extent that content does not contradict.

While the invention of the present application has been described above with reference to the example embodiments, the invention of the present application is not limited to the example embodiments described above. Various changes that can be understood by those skilled in the art can be made to the configuration and details of the invention of the present application within the scope of the present invention.

Note that, in a case where information relating to a user is acquired and utilized in the present invention, this is performed legally.

Some or all of the above-described example embodiments can also be described as, but are not limited to, the following supplementary notes.

1. A ticket checking system including:
a determination unit that determines, by face authentication, a person who has passed through a gate of a ticket barrier of transportation;
a settlement processing unit that performs settlement processing of a fare for the determined person;
a transmission unit that transmits, to a terminal of the determined person, information indicating that the transportation has been utilized; and
a refund processing unit that executes refund processing for the settled fare in a case where predetermined information is acquired from the terminal.
   2. The ticket checking system according to 1, further including
an authentication unit that narrows down, by use of position information of a user of the transportation, a person for whom the face authentication is to be performed, and performs face authentication processing regarding the narrowed-down person.
   3. The ticket checking system according to 1 or 2, wherein
master face information used for the face authentication or determination information linked to the master authentication information is stored in a storage unit in relation to presence or absence of commuter pass information of the person, and,
in a case where the commuter pass information of the person determined by the face authentication is absent in the storage unit, or in a case where it is decided based on the commuter pass information that the getting-on of the person is outside a section of a commuter pass, the settlement processing unit executes settlement processing of the fare.
   4. A ticket checking system including:
a gate control unit that permits, in a case where a payment method of a fare of transportation is a commuter pass, passage of a person for whom a face authentication result satisfies a first criterion through a gate of the ticket barrier of the transportation; and
a settlement processing unit that performs, in a case where the payment method is deposit balance payment, settlement processing of the fare for a person for whom the face authentication result satisfies a second criterion being tighter than the first criterion.
   5. The ticket checking system according to 4, wherein
the first criterion is that a score indicating the face authentication result is equal to or more than a first threshold value, and
the second criterion is being equal to or more than the first threshold value, and a person with the highest score among a plurality of persons who are successful in face authentication.
   6. The ticket checking system according to 4 or 5, wherein
the first criterion is that a score indicating the face authentication result is equal to or more than a first threshold value, and
the second criterion is that the score is equal to or more than a second threshold value being higher than the first threshold value.
   7. A ticket checking system including:
a decision unit that decides whether a payment method of a fare by a user of transportation is a commuter pass or deposit balance payment;
an authentication unit that sets a threshold value for face authentication according to the decided payment method, and performs the face authentication of the user by use of the threshold value;
a gate control unit that permits, in a case where the payment method is the commuter pass, passage of the user through a gate of a ticket barrier of the transportation in a case where the face authentication is successful; and
a settlement processing unit that performs, in a case where the payment method is the deposit balance payment, settlement processing of the fare for the user who is successful in the face authentication.
   8. The ticket checking system according to 7, wherein,
in a case where the payment method of the fare is deposit balance payment, the settlement processing unit performs settlement processing of the fare after passage through the gate,
the ticket checking system further including:
a transmission unit that transmits, to a terminal of a person for whom the settlement processing has been performed, information indicating that the transportation has been utilized; and
a refund processing unit that executes refund processing for the settled fare in a case where predetermined information is acquired from the terminal.
   9. The ticket checking system according to 7 or 8, further including
a second transmission unit that transmits, in a case where the payment method of the fare is deposit balance payment, information indicating that the transportation has been utilized, to a terminal of the person, after passage through the gate, wherein,
after acquiring predetermined information from the terminal, the settlement processing unit performs settlement processing of the fare.
   10. The ticket checking system according to 9, further including
a processing unit that executes predetermined processing for a person who does not perform the settlement processing equal to or more than a certain number of times.
   11. An information processing method including,
by one or more computers:
determining, by face authentication, a person who has passed through a gate of a ticket barrier of transportation;
performing settlement processing of a fare for the determined person;
transmitting, to a terminal of the determined person, information indicating that the transportation has been utilized; and
executing refund processing for the settled fare in a case where predetermined information is acquired from the terminal.
   12. The information processing method according to 11, further including,
by the one or more computers,
narrowing down, by use of position information of a user of the transportation, a person for whom the face authentication is to be performed, and performing face authentication processing regarding the narrowed-down person.
   13. The information processing method according to 11 or 12, wherein
master face information used for the face authentication or determination information linked to the master authentication information is stored in a storage unit in relation to presence or absence of commuter pass information of the person,
the information processing method further including,
by the one or more computers,
in a case where the commuter pass information of the person determined by the face authentication is absent in the storage unit, or in a case where it is decided based on the commuter pass information that the getting-on of the person is outside a section of a commuter pass, executing settlement processing of the fare.
   14. An information processing method including,
by one or more computers:
permitting, in a case where a payment method of a fare of transportation is a commuter pass, passage of a person for whom a face authentication result satisfies a first criterion through a gate of the ticket barrier of the transportation; and
performing, in a case where the payment method is deposit balance payment, settlement processing of the fare for a person for whom the face authentication result satisfies a second criterion being tighter than the first criterion.
   15. The information processing method according to 14, wherein
the first criterion is that a score indicating the face authentication result is equal to or more than a first threshold value, and
the second criterion is being equal to or more than the first threshold value, and a person with the highest score among a plurality of persons who are successful in face authentication.
   16. The information processing method according to 14 or 15, wherein
the first criterion is that a score indicating the face authentication result is equal to or more than a first threshold value, and
the second criterion is that the score is equal to or more than a second threshold value being higher than the first threshold value.
   17. An information processing method including,
by one or more computers:
deciding whether a payment method of a fare by a user of transportation is a commuter pass or deposit balance payment;
setting a threshold value for face authentication according to the decided payment method, and performing the face authentication of the user by use of the threshold value;
permitting, in a case where the payment method is the commuter pass, passage of the user through a gate of a ticket barrier of the transportation in a case where the face authentication is successful; and
performing, in a case where the payment method is the deposit balance payment, settlement processing of the fare for the user who is successful in the face authentication.
   18. The information processing method according to 17, further including,
by the one or more computers:
in a case where the payment method of the fare is deposit balance payment, performing settlement processing of the fare after passage through the gate;
transmitting, to a terminal of a person for whom the settlement processing has been performed, information indicating that the transportation has been utilized; and
executing refund processing for the settled fare in a case where predetermined information is acquired from the terminal.
   19. The information processing method according to 17 or 18, further including,
by the one or more computers:
transmitting, in a case where the payment method of the fare is deposit balance payment, information indicating that the transportation has been utilized, to a terminal of the person, after passage through the gate; and,
after acquiring predetermined information from the terminal, performing settlement processing of the fare.
   20. The information processing method according to 19, further including,
by the one or more computers,
executing predetermined processing for a person who does not perform the settlement processing equal to or more than a certain number of times.
   21. A computer-readable medium storing a program for causing a computer to execute:
a procedure of determining, by face authentication, a person who has passed through a gate of a ticket barrier of transportation;
a procedure of performing settlement processing of a fare for the determined person;
a procedure of transmitting, to a terminal of the determined person, information indicating that the transportation has been utilized; and
a procedure of executing refund processing for the settled fare in a case where predetermined information is acquired from the terminal.
   22. The computer-readable medium according to 21 recording a program for causing a computer to execute,
a procedure of narrowing down, by use of position information of a user of the transportation, a person for whom the face authentication is to be performed, and performing face authentication processing regarding the narrowed-down person.
   23. The computer-readable medium according to 21 or 22, wherein
master face information used for the face authentication or determination information linked to the master authentication information is stored in a storage unit in relation to presence or absence of commuter pass information of the person,
the computer-readable medium recording a program for causing a computer to execute,
a procedure of executing, in a case where the commuter pass information of the person determined by the face authentication is absent in the storage unit, or in a case where it is decided based on the commuter pass information that the getting-on of the person is outside a section of a commuter pass, settlement processing of the fare.
   24. A computer-readable medium storing a program for causing a computer to execute:
a procedure of permitting, in a case where a payment method of a fare of transportation is a commuter pass, passage of a person for whom a face authentication result satisfies a first criterion through a gate of the ticket barrier of the transportation; and
a procedure of performing, in a case where the payment method is deposit balance payment, settlement processing of the fare for a person for whom the face authentication result satisfies a second criterion being tighter than the first criterion.
   25. The computer-readable medium according to 24, wherein
the first criterion is that a score indicating the face authentication result is equal to or more than a first threshold value, and
the second criterion is being equal to or more than the first threshold value, and a person with the highest score among a plurality of persons who are successful in face authentication.
   26. The computer-readable medium according to 24 or 25, wherein
the first criterion is that a score indicating the face authentication result is equal to or more than a first threshold value, and
the second criterion is that the score is equal to or more than a second threshold value being higher than the first threshold value.
   27. A computer-readable medium storing a program for causing a computer to execute:
a procedure of deciding whether a payment method of a fare by a user of transportation is a commuter pass or deposit balance payment;
a procedure of setting a threshold value for face authentication according to the decided payment method, and performing the face authentication of the user by use of the threshold value;
a procedure of permitting, in a case where the payment method is the commuter pass, passage of the user through a gate of a ticket barrier of the transportation in a case where the face authentication is successful; and
a procedure of performing, in a case where the payment method is the deposit balance payment, settlement processing of the fare for the user who is successful in the face authentication.
   28. The computer-readable medium according to 27 recording a program for causing a computer to execute:
a procedure of performing, in a case where the payment method of the fare is deposit balance payment, settlement processing of the fare after passage through the gate;
a procedure of transmitting, to a terminal of a person for whom the settlement processing has been performed, information indicating that the transportation has been utilized; and
a procedure of executing refund processing for the settled fare in a case where predetermined information is acquired from the terminal.
   29. The computer-readable medium according to 27 or 28 recording a program for causing a computer to execute:
a procedure of transmitting, in a case where the payment method of the fare is deposit balance payment, information indicating that the transportation has been utilized, to a terminal of the person, after passage through the gate; and
a procedure of performing, after acquiring predetermined information from the terminal, settlement processing of the fare
   30. The computer-readable medium according to 29 recording a program for causing a computer to further execute,
a procedure of executing predetermined processing for a person who does not perform the settlement processing equal to or more than a certain number of times.
   31. A program for causing a computer to execute:
a procedure of determining, by face authentication, a person who has passed through a gate of a ticket barrier of transportation;
a procedure of performing settlement processing of a fare for the determined person;
a procedure of transmitting, to a terminal of the determined person, information indicating that the transportation has been utilized; and
a procedure of executing refund processing for the settled fare in a case where predetermined information is acquired from the terminal.
   32. The program according to 31 for causing the computer to execute,
a procedure of narrowing down, by use of position information of a user of the transportation, a person for whom the face authentication is to be performed, and performing face authentication processing regarding the narrowed-down person.
   33. The program according to 31 or 32, wherein
master face information used for the face authentication or determination information linked to the master authentication information is stored in a storage unit in relation to presence or absence of commuter pass information of the person,
the program for causing the computer to execute,
a procedure of executing, in a case where the commuter pass information of the person determined by the face authentication is absent in the storage unit, or in a case where it is decided based on the commuter pass information that the getting-on of the person is outside a section of a commuter pass, settlement processing of the fare.
   34. A program for causing a computer to execute:
a procedure of permitting, in a case where a payment method of a fare of transportation is a commuter pass, passage of a person for whom a face authentication result satisfies a first criterion through a gate of the ticket barrier of the transportation; and
a procedure of performing, in a case where the payment method is deposit balance payment, settlement processing of the fare for a person for whom the face authentication result satisfies a second criterion being tighter than the first criterion.
   35. The program according to 34, wherein
the first criterion is that a score indicating the face authentication result is equal to or more than a first threshold value, and
the second criterion is being equal to or more than the first threshold value, and a person with the highest score among a plurality of persons who are successful in face authentication.
   36. The program according to 34 or 35, wherein
the first criterion is that a score indicating the face authentication result is equal to or more than a first threshold value, and
the second criterion is that the score is equal to or more than a second threshold value being higher than the first threshold value.
   37. A program for causing a computer to execute:
a procedure of deciding whether a payment method of a fare by a user of transportation is a commuter pass or deposit balance payment;
a procedure of setting a threshold value for face authentication according to the decided payment method, and performing the face authentication of the user by use of the threshold value;
a procedure of permitting, in a case where the payment method is the commuter pass, passage of the user through a gate of a ticket barrier of the transportation in a case where the face authentication is successful; and
a procedure of performing, in a case where the payment method is the deposit balance payment, settlement processing of the fare for the user who is successful in the face authentication.
   38. The program according to 37 for causing the computer to execute:
a procedure of performing, in a case where the payment method of the fare is deposit balance payment, settlement processing of the fare after passage through the gate;
a procedure of transmitting, to a terminal of a person for whom the settlement processing has been performed, information indicating that the transportation has been utilized; and
a procedure of executing refund processing for the settled fare in a case where predetermined information is acquired from the terminal.
   39. The program according to 37 or 38 for causing the computer to execute:
a procedure of transmitting, in a case where the payment method of the fare is deposit balance payment, information indicating that the transportation has been utilized, to a terminal of the person, after passage through the gate; and
a procedure of performing, after acquiring predetermined information from the terminal, settlement processing of the fare.
   40. The program according to 39 for causing the computer to further execute,
a procedure of executing predetermined processing for a person who does not perform the settlement processing equal to or more than a certain number of times.

### REFERENCE SIGNS LIST

1 Ticket checking system
3 Communication network
5 Camera
10 Ticket gate machine
14 Gate
16 Passage
20 Display apparatus
30 User
40 User terminal
50 Ticket barrier control apparatus
100 Information processing apparatus
102 Determination unit
104 Settlement processing unit
106 Transmission unit
108 Refund processing unit
110 Authentication unit
112 Demand notification unit
120 Gate control unit
130 Decision unit
132 Countermeasure processing unit
150 Storage apparatus
160 Master authentication information
170 Means of transportation utilization information
180 User information
200 Notification screen
202 Utilization date and time display unit
204 Utilization section display unit
206 Fare display unit
210 Message display unit
212 Consent button
214 Refund request button
220 Fare demand amount display unit
222 Reject button
1000 Computer
1010 Bus
1020 Processor
1030 Memory
1040 Storage device
1050 Input/output interface
1060 Network interface

What is claimed is:

1. A ticket checking system comprising:
at least one memory storing instructions; and
at least one processor configured to execute the instructions to:
determine, by face authentication, a person who has passed through a gate of a ticket barrier of transportation;
perform settlement processing of a fare for the determined person;
transmit, to a terminal of the determined person, information indicating that the transportation has been utilized; and
execute refund processing for the settled fare in a case where predetermined information is acquired from the terminal.

2. The ticket checking system according to claim 1, wherein the at least one processor is further configured to execute the instructions to
narrow down, by use of position information of a user of the transportation, a person for whom the face authentication is to be performed, and perform face authentication processing regarding the narrowed-down person.

3. The ticket checking system according to claim 1, wherein
master face information used for the face authentication or determination information linked to the master authentication information is stored in a storage unit in relation to presence or absence of commuter pass information of the person, and,
the at least one processor is further configured to execute the instructions to, in a case where the commuter pass information of the person determined by the face authentication is absent in the storage unit, or in a case where it is decided based on the commuter pass information that the getting-on of the person is outside a section of a commuter pass, execute settlement processing of the fare.

4-10. (canceled)

11. An information processing method comprising,
by one or more computers:
determining, by face authentication, a person who has passed through a gate of a ticket barrier of transportation;
performing settlement processing of a fare for the determined person;
transmitting, to a terminal of the determined person, information indicating that the transportation has been utilized; and
executing refund processing for the settled fare in a case where predetermined information is acquired from the terminal.

12. The information processing method according to claim 11, further comprising,
by the one or more computers,
narrowing down, by use of position information of a user of the transportation, a person for whom the face authentication is to be performed, and performing face authentication processing regarding the narrowed-down person.

13. The information processing method according to claim 11 or 12, wherein
master face information used for the face authentication or determination information linked to the master authentication information is stored in a storage unit in relation to presence or absence of commuter pass information of the person,
the information processing method further comprising,
by the one or more computers,
in a case where the commuter pass information of the person determined by the face authentication is absent in the storage unit, or in a case where it is decided based on the commuter pass information that the getting-on of the person is outside a section of a commuter pass, executing settlement processing of the fare.

14-20. (canceled)

21. A non-transitory computer-readable medium storing a program for causing a computer to execute:
a procedure of determining, by face authentication, a person who has passed through a gate of a ticket barrier of transportation;
a procedure of performing settlement processing of a fare for the determined person;
a procedure of transmitting, to a terminal of the determined person, information indicating that the transportation has been utilized; and
a procedure of executing refund processing for the settled fare in a case where predetermined information is acquired from the terminal.

22. The non-transitory computer-readable medium according to claim 21 recording a program for causing a computer to execute,
a procedure of narrowing down, by use of position information of a user of the transportation, a person for whom the face authentication is to be performed, and performing face authentication processing regarding the narrowed-down person.

23. The non-transitory computer-readable medium according to claim 21, wherein
master face information used for the face authentication or determination information linked to the master authentication information is stored in a storage unit in relation to presence or absence of commuter pass information of the person,
the computer-readable medium recording a program for causing a computer to execute,
a procedure of executing, in a case where the commuter pass information of the person determined by the face authentication is absent in the storage unit, or in a case where it is decided based on the commuter pass information that the getting-on of the person is outside a section of a commuter pass, settlement processing of the fare.

24-30. (canceled)
